(19) United States
(12) Patent Application Publication
(10) Pub. No.: US 2017/0238313 A1
(43) Pub. Date: Aug. 17, 2017

(54) DATA TRANSMISSION METHOD, DEVICE, AND SYSTEM

(71) Applicant: Huawei Technologies Co., Ltd., Shenzhen (CN)

(72) Inventors: Jian WANG, Beijing (CN); Chao LI, Beijing (CN); Xingwei ZHANG, Beijing (CN)

(21) Appl. No.: 15/502,153

(22) PCT Filed: Aug. 7, 2014
(86) PCT No.: PCT/CN2014/083905

§ 371 Date: Feb. 6, 2017

(51) Int. Cl. H04W 72/04

(52) U.S. Cl. CPC H04W 72/0446; H04W 72/0413

(57) ABSTRACT

A method includes: determining, by a first device, a frequency hopping parameter and a quantity of retransmission times of to-be-transmitted data, wherein the frequency hopping parameter comprises an initial frequency hopping location, a bandwidth of the to-be-transmitted data, a frequency hopping offset, and a total frequency hopping bandwidth; determining, by the first device, a first start location of the to-be-transmitted data according to the quantity of retransmission times of the to-be-transmitted data and the frequency hopping parameter; and sending, by the first device, the to-be-transmitted data to a second device according to the first start location and the bandwidth of the to-be-transmitted data.

### CROSS-REFERENCE TO RELATED APPLICATIONS

This application is a national stage of International Application No. PCT/CN2014/083905, filed on Aug. 7, 2014, which is hereby incorporated by reference in its entirety.

### TECHNICAL FIELD

Embodiments of the present invention relate to communications technologies, and in particular, to a data transmission method, a device, and a system.

### BACKGROUND

A channel in a wireless communications system generally has an unstable feature in terms of time and reflects a particular frequency domain selectivity in terms of a frequency domain. In a Long Term Evolution (English full name: Long Term Evolution, English acronym: LTE) system including a physical uplink control channel (English full name: Physical Uplink Control Channel, English acronym: PUCCH), a frequency hopping manner of a fixed-format PUCCH is fixed. For example, a case in which the PUCCH occupies a bandwidth may be: In an even timeslot, a bandwidth occupied by the PUCCH is located in a lowest frequency band of a total bandwidth of the wireless communications system. In an odd timeslot, a bandwidth occupied by the PUCCH is located in a highest frequency band of the total bandwidth of the wireless communications system. Therefore, for the fixed-format PUCCH, frequency bands occupied by the PUCCH by means of frequency hopping are always located at two ends of the total bandwidth of the wireless communication system.

However, a frequency diversity gain that can be obtained is relatively small when a data packet is transmitted by using the method in which bandwidths occupied by the PUCCH are always centralized at two ends of the total bandwidth of the wireless communications system.

### SUMMARY

Embodiments of the present invention provide a data transmission method, a device, and a system, so as to obtain a larger frequency diversity gain during data packet transmission.

According to a first aspect, an embodiment of the present invention provides a data transmission method, including:
determining, by a first device, a frequency hopping parameter and a quantity of retransmission times of to-be-transmitted data, where the frequency hopping parameter includes an initial frequency hopping location, a bandwidth of the to-be-transmitted data, a frequency hopping offset, and a total frequency hopping bandwidth;
determining, by the first device, a first start location of the to-be-transmitted data according to the quantity of retransmission times of the to-be-transmitted data and the frequency hopping parameter; and
sending, by the first device, the to-be-transmitted data to a second device according to the first start location and the bandwidth of the to-be-transmitted data.

With reference to the first aspect, in a first possible implementation manner of the first aspect, the frequency hopping parameter further includes a maximum quantity of retransmission times of the to-be-transmitted data.

With reference to the first aspect or the first possible implementation manner of the first aspect, in a second possible implementation manner of the first aspect, the determining, by the first device, a first start location of the to-be-transmitted data according to the quantity of retransmission times of the to-be-transmitted data and the frequency hopping parameter includes:
if a current retransmission subframe belongs to a first time subset, determining, by the first device, the first start location of the to-be-transmitted data from a relatively low frequency location to a relatively high frequency location according to the initial frequency hopping location, the bandwidth of the to-be-transmitted data, the total frequency hopping bandwidth, and a product of the quantity of retransmission times and the frequency hopping offset; or if a current retransmission subframe belongs to a second time subset, determining, by the first device, the first start location of the to-be-transmitted data from a relatively high frequency location to a relatively low frequency location according to the initial frequency hopping location, the bandwidth of the to-be-transmitted data, the total frequency hopping bandwidth, and a product of the quantity of retransmission times and the frequency hopping offset.

With reference to the second possible implementation manner of the first aspect, in a third possible implementation manner of the first aspect, the first time subset and the second time subset are the same or different.

With reference to the third possible implementation manner of the first aspect, in a fourth possible implementation manner of the first aspect, the first time subset and the second time subset include any one of the following time subsets:
a time set including an even subframe;
a time set including an odd subframe;
a time set including a subframe corresponding to a subframe index when a sum of the quantity of retransmission times of the to-be-transmitted data and the subframe index is an even number;
a time set including a subframe corresponding to a subframe index when a sum of the quantity of retransmission times of the to-be-transmitted data and the subframe index is an odd number; or
a time set including all subframes.

With reference to the first aspect or the first possible implementation manner of the first aspect, in a fifth possible implementation manner of the first aspect, the determining, by the first device, a first start location of the to-be-transmitted data according to the quantity of retransmission times of the to-be-transmitted data and the frequency hopping parameter includes:
determining, by the first device, the first start location based on an existing formula for calculating a frequency hopping frequency domain location and according to the initial frequency hopping location, the bandwidth of the to-be-transmitted data, the total frequency hopping bandwidth, and a product of the quantity of retransmission times and the frequency hopping offset.

With reference to the first aspect or the first possible implementation manner of the first aspect, in a sixth possible implementation manner of the first aspect, the determining, by the first device, a first start location of the to-be-transmitted data according to the quantity of retransmission times of the to-be-transmitted data and the frequency hopping parameter includes:
obtaining, by the first device, a frequency hopping function according to the quantity of retransmission times, where the frequency hopping function is a calculation factor in an existing formula for calculating a frequency hopping frequency domain location; and
determining, by the first device, the first start location according to the frequency hopping function, the frequency hopping parameter, and a product of the quantity of retransmission times and the frequency hopping offset.

With reference to the sixth possible implementation manner of the first aspect, in a seventh possible implementation manner of the first aspect, the obtaining, by the first device, a frequency hopping function according to the quantity of retransmission times includes:
generating, by the first device, a random sequence in the frequency hopping function according to the quantity of retransmission times, so as to obtain the frequency hopping function corresponding to the quantity of retransmission times; or
generating, by the first device according to the quantity of retransmission times, a location in which a random sequence in the frequency hopping function is read, so as to obtain the frequency hopping function corresponding to the quantity of retransmission times.

With reference to the first aspect or the first possible implementation manner of the first aspect, in an eighth possible implementation manner of the first aspect, the total frequency hopping bandwidth is a dedicated bandwidth used during data transmission from the first device to the second device, and the determining, by the first device, a first start location of the to-be-transmitted data according to the quantity of retransmission times of the to-be-transmitted data and the frequency hopping parameter includes:
determining, by the first device within a range of the dedicated bandwidth, the first start location of the to-be-transmitted data according to the quantity of retransmission times of the to-be-transmitted data and the frequency hopping parameter; and
mapping, by the first device, the first start location to a physical resource of a system bandwidth.

With reference to the eighth possible implementation manner of the first aspect, in a ninth possible implementation manner of the first aspect, after the determining, by a first device, a frequency hopping parameter and a quantity of retransmission times of to-be-transmitted data, the method further includes:
sending, by the first device within the range of the dedicated bandwidth, signaling used to indicate the initial frequency hopping location to the second device.

According to a second aspect, an embodiment of the present invention provides a data transmission method, including:
determining, by a first device, a frequency hopping parameter, where the frequency hopping parameter includes an initial frequency hopping location, a bandwidth of to-be-transmitted data, and a total frequency hopping bandwidth;
determining, by the first device, a first start location of the to-be-transmitted data according to the frequency hopping parameter; and
sending, by the first device, the to-be-transmitted data to a second device according to the first start location and the bandwidth of the to-be-transmitted data.

With reference to the second aspect, in a first possible implementation manner of the second aspect, the determining, by the first device, a first start location of the to-be-transmitted data according to the frequency hopping parameter includes:
if a current retransmission subframe belongs to a first time subset, determining, by the first device, the first start location of the to-be-transmitted data according to the initial frequency hopping location and the total frequency hopping bandwidth; or if a current retransmission subframe belongs to a second time subset, determining, by the first device, the first start location of the to-be-transmitted data according to the initial frequency hopping location, the bandwidth of the to-be-transmitted data, and the total frequency hopping bandwidth.

With reference to the second aspect, in a second possible implementation manner of the second aspect, the frequency hopping parameter further includes a maximum quantity of retransmission times of the to-be-transmitted data, and before the determining, by the first device, a first start location of the to-be-transmitted data according to the frequency hopping parameter, the method further includes:
determining, by the first device, whether the maximum quantity of retransmission times is not greater than 2; and
the determining, by the first device, a first start location of the to-be-transmitted data according to the frequency hopping parameter includes:
if the maximum quantity of retransmission times is not greater than 2 and a current retransmission subframe belongs to a first time subset, determining, by the first device, the first start location according to the initial frequency hopping location and the total frequency hopping bandwidth; or if the maximum quantity of retransmission times is not greater than 2 and a current retransmission subframe belongs to a second time subset, determining, by the first device, the first start location according to the initial frequency hopping location, the bandwidth of the to-be-transmitted data, and the total frequency hopping bandwidth.

With reference to the second aspect, in a third possible implementation manner of the second aspect, the total frequency hopping bandwidth is a dedicated bandwidth used during data transmission from the first device to the second device, and the determining, by the first device, a first start location of the to-be-transmitted data according to the frequency hopping parameter includes:
determining, by the first device within a range of the dedicated bandwidth, the first start location of the to-be-transmitted data according to the frequency hopping parameter; and
mapping, by the first device, the first start location to a physical resource of a system bandwidth.

With reference to the third possible implementation manner of the second aspect, in a fourth possible implementation manner of the second aspect, after the determining, by a first device, a frequency hopping parameter, the method further includes:
sending, by the first device within the range of the dedicated bandwidth, signaling used to indicate the initial frequency hopping location to the second device.

According to a third aspect, an embodiment of the present invention provides a data transmission method, including:
determining, by a second device, a frequency hopping parameter and a quantity of retransmission times of to-be-received data, where the frequency hopping parameter includes an initial frequency hopping location, a bandwidth of the to-be-received data, a frequency hopping offset, and a total frequency hopping bandwidth;
determining, by the second device, a first start location of the to-be-received data according to the quantity of retransmission times of the to-be-received data and the frequency hopping parameter; and
receiving, by the second device according to the first start location and the bandwidth of the to-be-received data, the to-be-received data sent by a first device.

With reference to the third aspect, in a first possible implementation manner of the third aspect, the frequency hopping parameter further includes a maximum quantity of retransmission times of the to-be-received data.

With reference to the third aspect or the first possible implementation manner of the third aspect, in a second possible implementation manner of the third aspect, the determining, by the second device, a first start location of the to-be-received data according to the quantity of retransmission times of the to-be-received data and the frequency hopping parameter includes:
if a current retransmission subframe belongs to a first time subset, determining, by the second device, the first start location of the to-be-received data from a relatively low frequency location to a relatively high frequency location according to the initial frequency hopping location, the bandwidth of the to-be-received data, the total frequency hopping bandwidth, and a product of the quantity of retransmission times and the frequency hopping offset; or if a current retransmission subframe belongs to a second time subset, determining, by the second device, the first start location of the to-be-received data from a relatively high frequency location to a relatively low frequency location according to the initial frequency hopping location, the bandwidth of the to-be-received data, the total frequency hopping bandwidth, and a product of the quantity of retransmission times and the frequency hopping offset.

With reference to the second possible implementation manner of the third aspect, in a third possible implementation manner of the third aspect, the first time subset and the second time subset are the same or different.

With reference to the third possible implementation manner of the third aspect, in a fourth possible implementation manner of the third aspect, the first time subset and the second time subset include any one of the following time subsets:
a time set including an even subframe;
a time set including an odd subframe;
a time set including a subframe corresponding to a subframe index when a sum of the quantity of retransmission times of the to-be-received data and the subframe index is an even number;
a time set including a subframe corresponding to a subframe index when a sum of the quantity of retransmission times of the to-be-received data and the subframe index is an odd number; or
a time set including all subframes.

With reference to the third aspect or the first possible implementation manner of the third aspect, in a fifth possible implementation manner of the third aspect, the determining, by the second device, a first start location of the to-be-received data according to the quantity of retransmission times of the to-be-received data and the frequency hopping parameter includes:
determining, by the second device, the first start location based on an existing formula for calculating a frequency hopping frequency domain location and according to the initial frequency hopping location, the bandwidth of the to-be-received data, the total frequency hopping bandwidth, and a product of the quantity of retransmission times and the frequency hopping offset.

With reference to the third aspect or the first possible implementation manner of the third aspect, in a sixth possible implementation manner of the third aspect, the determining, by the second device, a first start location of the to-be-received data according to the quantity of retransmission times of the to-be-received data and the frequency hopping parameter includes:
obtaining, by the second device, a frequency hopping function according to the quantity of retransmission times, where the frequency hopping function is a calculation factor in an existing formula for calculating a frequency hopping frequency domain location; and
determining, by the second device, the first start location according to the frequency hopping function, the frequency hopping parameter, and a product of the quantity of retransmission times and the frequency hopping offset.

With reference to the sixth possible implementation manner of the third aspect, in a seventh possible implementation manner of the third aspect, the obtaining, by the second device, a frequency hopping function according to the quantity of retransmission times includes:
generating, by the second device, a random sequence in the frequency hopping function according to the quantity of retransmission times, so as to obtain the frequency hopping function corresponding to the quantity of retransmission times; or
generating, by the second device according to the quantity of retransmission times, a location in which a random sequence in the frequency hopping function is read, so as to obtain the frequency hopping function corresponding to the quantity of retransmission times.

With reference to the third aspect or the first possible implementation manner of the third aspect, in an eighth possible implementation manner of the third aspect, the total frequency hopping bandwidth is a dedicated bandwidth used during data receiving by the second device from the first device, and the determining, by the second device, a first start location of the to-be-received data according to the quantity of retransmission times of the to-be-received data and the frequency hopping parameter includes:
determining, by the second device, the first start location of the to-be-received data within a range of the dedicated bandwidth according to the quantity of retransmission times of the to-be-received data and the frequency hopping parameter; and
mapping, by the second device, the first start location to a physical resource of a system bandwidth.

With reference to the eighth possible implementation manner of the third aspect, in a ninth possible implementation manner of the third aspect, after the determining, by a second device, a frequency hopping parameter and a quantity of retransmission times of to-be-received data, the method further includes:
receiving, by the second device within the range of the dedicated bandwidth, signaling used to indicate the initial frequency hopping location.

According to a fourth aspect, an embodiment of the present invention provides a data transmission method, including:
determining, by a second device, a frequency hopping parameter, where the frequency hopping parameter includes an initial frequency hopping location, a bandwidth of to-be-received data, and a total frequency hopping bandwidth;
determining, by the second device, a first start location of the to-be-received data according to the frequency hopping parameter; and
receiving, by the second device according to the first start location and the bandwidth of the to-be-received data, the to-be-received data sent by a first device.

With reference to the fourth aspect, in a first possible implementation manner of the fourth aspect, the determining, by the second device, a first start location of the to-be-received data according to the frequency hopping parameter includes:
if a current retransmission subframe belongs to a first time subset, determining, by the second device, the first start location of the to-be-received data according to the initial frequency hopping location and the total frequency hopping bandwidth; or if a current retransmission subframe belongs to a second time subset, determining, by the second device, the first start location of the to-be-received data according to the initial frequency hopping location, the bandwidth of the to-be-received data, and the total frequency hopping bandwidth.

With reference to the fourth aspect, in a second possible implementation manner of the fourth aspect, the frequency hopping parameter further includes a maximum quantity of retransmission times of the to-be-received data, and before the determining, by the second device, a first start location of the to-be-received data according to the frequency hopping parameter, the method further includes:
determining, by the second device, whether the maximum quantity of retransmission times is not greater than 2; and
the determining, by the second device, a first start location of the to-be-received data according to the frequency hopping parameter includes:
if the maximum quantity of retransmission times is not greater than 2 and a current retransmission subframe belongs to a first time subset, determining, by the second device, the first start location according to the initial frequency hopping location and the total frequency hopping bandwidth; or if the maximum quantity of retransmission times is not greater than 2 and a current retransmission subframe belongs to a second time subset, determining, by the second device, the first start location according to the initial frequency hopping location, the bandwidth of the to-be-received data, and the total frequency hopping bandwidth.

With reference to the fourth aspect, in a third possible implementation manner of the fourth aspect, the total frequency hopping bandwidth is a dedicated bandwidth used during data transmission from the first device to the second device, and the determining, by the second device, a first start location of the to-be-received data according to the frequency hopping parameter includes:
determining, by the second device within a range of the dedicated bandwidth, the first start location of the to-be-received data according to the frequency hopping parameter; and
mapping, by the second device, the first start location to a physical resource of a system bandwidth.

With reference to the third possible implementation manner of the fourth aspect, in a fourth possible implementation manner of the fourth aspect, after the determining, by a second device, a frequency hopping parameter, the method further includes:
receiving, by the second device within the range of the dedicated bandwidth, signaling used to indicate the initial frequency hopping location.

According to a fifth aspect, an embodiment of the present invention provides a device, including:
a first determining module, configured to determine a frequency hopping parameter and a quantity of retransmission times of to-be-transmitted data, where the frequency hopping parameter includes an initial frequency hopping location, a bandwidth of the to-be-transmitted data, a frequency hopping offset, and a total frequency hopping bandwidth;
a second determining module, configured to determine a first start location of the to-be-transmitted data according to the quantity of retransmission times of the to-be-transmitted data and the frequency hopping parameter; and
a sending module, configured to send the to-be-transmitted data to a second device according to the first start location and the bandwidth of the to-be-transmitted data.

With reference to the fifth aspect, in a first possible implementation manner of the fifth aspect, the frequency hopping parameter further includes a maximum quantity of retransmission times of the to-be-transmitted data.

With reference to the fifth aspect or the first possible implementation manner of the fifth aspect, in a second possible implementation manner of the fifth aspect, the second determining module is specifically configured to: if a current retransmission subframe belongs to a first time subset, determine the first start location of the to-be-transmitted data from a relatively low frequency location to a relatively high frequency location according to the initial frequency hopping location, the bandwidth of the to-be-transmitted data, the total frequency hopping bandwidth, and a product of the quantity of retransmission times and the frequency hopping offset; or if a current retransmission subframe belongs to a second time subset, determine the first start location of the to-be-transmitted data from a relatively high frequency location to a relatively low frequency location according to the initial frequency hopping location, the bandwidth of the to-be-transmitted data, the total frequency hopping bandwidth, and a product of the quantity of retransmission times and the frequency hopping offset.

With reference to the second possible implementation manner of the fifth aspect, in a third possible implementation manner of the fifth aspect, the first time subset and the second time subset are the same or different.

With reference to the third possible implementation manner of the fifth aspect, in a fourth possible implementation manner of the fifth aspect, the first time subset and the second time subset include any one of the following time subsets:
a time set including an even subframe;
a time set including an odd subframe;
a time set including a subframe corresponding to a subframe index when a sum of the quantity of retransmission times of the to-be-transmitted data and the subframe index is an even number;
a time set including a subframe corresponding to a subframe index when a sum of the quantity of retransmission times of the to-be-transmitted data and the subframe index is an odd number; or
a time set including all subframes.

With reference to the fifth aspect or the first possible implementation manner of the fifth aspect, in a fifth possible implementation manner of the fifth aspect, the second determining module is specifically configured to determine the first start location based on an existing formula for calculating a frequency hopping frequency domain location and according to the initial frequency hopping location, the bandwidth of the to-be-transmitted data, the total frequency hopping bandwidth, and a product of the quantity of retransmission times and the frequency hopping offset.

With reference to the fifth aspect or the first possible implementation manner of the fifth aspect, in a sixth possible implementation manner of the fifth aspect, the second determining module is specifically configured to: obtain a frequency hopping function according to the quantity of retransmission times, where the frequency hopping function is a calculation factor in an existing formula for calculating a frequency hopping frequency domain location; and determine the first start location according to the frequency hopping function, the frequency hopping parameter, and a product of the quantity of retransmission times and the frequency hopping offset.

With reference to the sixth possible implementation manner of the fifth aspect, in a seventh possible implementation manner of the fifth aspect, the second determining module is further configured to: generate a random sequence in the frequency hopping function according to the quantity of retransmission times, so as to obtain the frequency hopping function corresponding to the quantity of retransmission times; or generate, according to the quantity of retransmission times, a location in which a random sequence in the frequency hopping function is read, so as to obtain the frequency hopping function corresponding to the quantity of retransmission times.

With reference to the fifth aspect or the first possible implementation manner of the fifth aspect, in an eighth possible implementation manner of the fifth aspect, the total frequency hopping bandwidth is a dedicated bandwidth used during data transmission, and the second determining module is specifically configured to determine, within a range of the dedicated bandwidth, the first start location of the to-be-transmitted data according to the quantity of retransmission times of the to-be-transmitted data and the frequency hopping parameter, and map the first start location to a physical resource of a system bandwidth.

With reference to the eighth possible implementation manner of the fifth aspect, in a ninth possible implementation manner of the fifth aspect, the sending module is further configured to send, within the range of the dedicated bandwidth, signaling used to indicate the initial frequency hopping location to the second device.

According to a sixth aspect, an embodiment of the present invention provides a device, including:
a first determining module, configured to determine a frequency hopping parameter, where the frequency hopping parameter includes an initial frequency hopping location, a bandwidth of to-be-transmitted data, and a total frequency hopping bandwidth;
a second determining module, configured to determine a first start location of the to-be-transmitted data according to the frequency hopping parameter; and
a sending module, configured to send the to-be-transmitted data to a second device according to the first start location and the bandwidth of the to-be-transmitted data.

With reference to the sixth aspect, in a first possible implementation manner of the sixth aspect, the second determining module is specifically configured to: if a current retransmission subframe belongs to a first time subset, determine the first start location of the to-be-transmitted data according to the initial frequency hopping location and the total frequency hopping bandwidth; or if a current retransmission subframe belongs to a second time subset, determine the first start location of the to-be-transmitted data according to the initial frequency hopping location, the bandwidth of the to-be-received data, and the total frequency hopping bandwidth.

With reference to the sixth aspect, in a second possible implementation manner of the sixth aspect, the second determining module is specifically configured to: determine whether the maximum quantity of retransmission times is not greater than 2; and if the maximum quantity of retransmission times is not greater than 2 and a current retransmission subframe belongs to a first time subset, determine the first start location according to the initial frequency hopping location and the total frequency hopping bandwidth, or if the maximum quantity of retransmission times is not greater than 2 and a current retransmission subframe belongs to a second time subset, determine the first start location according to the initial frequency hopping location, the bandwidth of the to-be-transmitted data, and the total frequency hopping bandwidth.

With reference to the sixth aspect, in a third possible implementation manner of the sixth aspect, the total frequency hopping bandwidth is a dedicated bandwidth used during data transmission, and the second determining module is specifically configured to determine, by the first device, within a range of the dedicated bandwidth, the first start location of the to-be-transmitted data according to the frequency hopping parameter, and map the first start location to a physical resource of a system bandwidth.

With reference to the third possible implementation manner of the sixth aspect, in a fourth possible implementation manner of the sixth aspect, the sending module is further configured to send, within the range of the dedicated bandwidth, signaling used to indicate the initial frequency hopping location to the second device.

According to a seventh aspect, an embodiment of the present invention provides a device, including:
a first determining module, configured to determine a frequency hopping parameter and a quantity of retransmission times of to-be-received data, where the frequency hopping parameter includes an initial frequency hopping location, a bandwidth of the to-be-received data, a frequency hopping offset, and a total frequency hopping bandwidth;
a second determining module, configured to determine a first start location of the to-be-received data according to the quantity of retransmission times of the to-be-received data and the frequency hopping parameter; and
a receiving module, configured to receive, according to the first start location and the bandwidth of the to-be-received data, the to-be-received data sent by a first device.

With reference to the seventh aspect, in a first possible implementation manner of the seventh aspect, the frequency hopping parameter further includes a maximum quantity of retransmission times of the to-be-received data.

With reference to the seventh aspect or the first possible implementation manner of the seventh aspect, in a second possible implementation manner of the seventh aspect, the second determining module is specifically configured to: if a current retransmission subframe belongs to a first time subset, determine the first start location of the to-be-received data from a relatively low frequency location to a relatively high frequency location according to the initial frequency hopping location, the bandwidth of the to-be-received data, the total frequency hopping bandwidth, and a product of the quantity of retransmission times and the frequency hopping offset; or if a current retransmission subframe belongs to a second time subset, determine the first start location of the to-be-received data from a relatively high frequency location to a relatively low frequency location according to the initial frequency hopping location, the bandwidth of the to-be-received data, the total frequency hopping bandwidth, and a product of the quantity of retransmission times and the frequency hopping offset.

With reference to the second possible implementation manner of the seventh aspect, in a third possible implementation manner of the seventh aspect, the first time subset and the second time subset are the same or different.

With reference to the third possible implementation manner of the seventh aspect, in a fourth possible implementation manner of the seventh aspect, the first time subset and the second time subset include any one of the following time subsets:
a time set including an even subframe;
a time set including an odd subframe;
a time set including a subframe corresponding to a subframe index when a sum of the quantity of retransmission times of the to-be-received data and the subframe index is an even number;
a time set including a subframe corresponding to a subframe index when a sum of the quantity of retransmission times of the to-be-received data and the subframe index is an odd number; or
a time set including all subframes.

With reference to the seventh aspect of the first possible implementation manner of the seventh aspect, in a fifth possible implementation manner of the seventh aspect, the determining module is specifically configured to determine the first start location based on an existing formula for calculating a frequency hopping frequency domain location and according to the initial frequency hopping location, the bandwidth of the to-be-received data, the total frequency hopping bandwidth, and a product of the quantity of retransmission times and the frequency hopping offset.

With reference to the seventh aspect or the first possible implementation manner of the seventh aspect, in a sixth possible implementation manner of the seventh aspect, the second determining module is specifically configured to: obtain a frequency hopping function according to the quantity of retransmission times, where the frequency hopping function is a calculation factor in an existing formula for calculating a frequency hopping frequency domain location; and determine the first start location according to the frequency hopping function, the frequency hopping parameter, and a product of the quantity of retransmission times and the frequency hopping offset.

With reference to the sixth possible implementation manner of the seventh aspect, in a seventh possible implementation manner of the seventh aspect, the second determining module is further configured to: generate a random sequence in the frequency hopping function according to the quantity of retransmission times, so as to obtain the frequency hopping function corresponding to the quantity of retransmission times; or generate, according to the quantity of retransmission times, a location in which a random sequence in the frequency hopping function is read, so as to obtain the frequency hopping function corresponding to the quantity of retransmission times.

With reference to the seventh aspect or the first possible implementation manner of the seventh aspect, in an eighth possible implementation manner of the seventh aspect, the total frequency hopping bandwidth is a dedicated bandwidth used during data transmission, and the determining module is specifically configured to determine, within a range of the dedicated bandwidth, the first start location of the to-be-received data according to the quantity of retransmission times of the to-be-received data and the frequency hopping parameter, and map the first start location to a physical resource of a system bandwidth.

With reference to the eighth possible implementation manner of the seventh aspect, in a ninth possible implementation manner of the seventh aspect, the receiving module is further configured to receive, within the range of the dedicated bandwidth, signaling used to indicate the initial frequency hopping location.

According to an eighth aspect, an embodiment of the present invention provides a device, including:
a first determining module, configured to determine a frequency hopping parameter, where the frequency hopping parameter includes an initial frequency hopping location, a bandwidth of to-be-received data, and a total frequency hopping bandwidth;
a second determining module, configured to determine a first start location of the to-be-received data according to the frequency hopping parameter; and
a receiving module, configured to receive, according to the first start location and the bandwidth of the to-be-received data, the to-be-received data sent by a first device.

With reference to the eighth aspect, in a first possible implementation manner of the eighth aspect, the second determining module is specifically configured to: if a current retransmission subframe belongs to a first time subset, determine the first start location of the to-be-received data according to the initial frequency hopping location and the total frequency hopping bandwidth; or if a current retransmission subframe belongs to a second time subset, determine the first start location of the to-be-received data according to the initial frequency hopping location, the bandwidth of the to-be-received data, and the total frequency hopping bandwidth.

With reference to the eighth aspect, in a second possible implementation manner of the eighth aspect, the frequency hopping parameter further includes a maximum quantity of retransmission times of the to-be-received data, and the second determining module is specifically configured to: determine whether the maximum quantity of retransmission times is not greater than 2; and if the maximum quantity of retransmission times is not greater than 2 and a current retransmission subframe belongs to a first time subset, determine the first start location according to the initial frequency hopping location and the total frequency hopping bandwidth, or if the maximum quantity of retransmission times is not greater than 2 and a current retransmission subframe belongs to a second time subset, determine the first start location according to the initial frequency hopping location, the bandwidth of the to-be-received data, and the total frequency hopping bandwidth.

With reference to the eighth aspect, in a third possible implementation manner of the eighth aspect, the total frequency hopping bandwidth is a dedicated bandwidth used during data transmission, and the second determining module is specifically configured to determine, within a range of the dedicated bandwidth, the first start location of the to-be-received data according to the frequency hopping parameter, and map the first start location to a physical resource of a system bandwidth.

With reference to the third possible implementation manner of the eighth aspect, in a fourth possible implementation manner of the eighth aspect, the receiving module is further configured to receive, within the range of the dedicated bandwidth, signaling used to indicate the initial frequency hopping location.

According to a ninth aspect, an embodiment of the present invention provides a wireless system, including: the device according to any one of the fifth aspect or the first to the ninth possible implementation manners of the fifth aspect and the device according to any one of the seventh aspect, the first to the ninth possible implementation manners of the seventh aspect, or the eighth aspect; or the device according to any one of the sixth aspect or the first to the fourth possible implementation manners of the sixth aspect and the device according to any one of the first to the fourth possible implementation manners of the eighth aspect.

According to the data transmission method, the device, and the system provided in the embodiments of the present invention, a larger frequency diversity gain can be obtained during data packet transmission.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic diagram of an application scenario of a data transmission method according to the present invention;

FIG. 2 is a flowchart of an embodiment of a data transmission method according to the present invention;

FIG. 3 is a flowchart of another embodiment of a data transmission method according to the present invention;

FIG. 4 is a schematic diagram of frequency domain resource mapping;

FIG. 5 is a flowchart of still another embodiment of a data transmission method according to the present invention;

FIG. 6 is a flowchart of yet another embodiment of a data transmission method according to the present invention;

FIG. 7 is a flowchart of yet another embodiment of a data transmission method according to the present invention;

FIG. 8 is a schematic structural diagram of an embodiment of a device according to the present invention;

FIG. 9 is a schematic structural diagram of an embodiment of a device according to the present invention;

FIG. 10 is a schematic structural diagram of an embodiment of a device according to the present invention;

FIG. 11 is a schematic structural diagram of an embodiment of a device according to the present invention;

FIG. 12 is a schematic structural diagram of an embodiment of a wireless system according to the present invention;

FIG. 13 is a schematic structural diagram of an embodiment of a device according to the present invention; and

FIG. 14 is a schematic structural diagram of an embodiment of a device according to the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

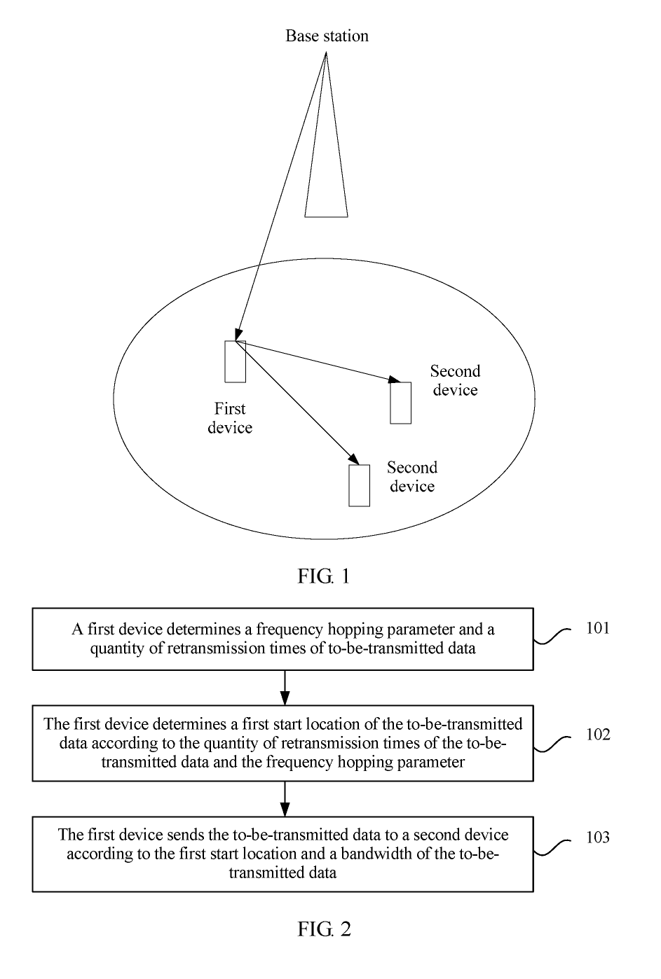

FIG. 1 is a schematic diagram of an application scenario of a data transmission method according to the present invention. As shown in FIG. 1, the application scenario includes a base station, a first device, and a second device. The base station includes but is not limited to a base station in any wireless communications system (for example, a wireless communications system using an LTE technology). The first device and the second device include any device that supports D2D (English full name: Device to Device, English acronym: D2D) communication, and “first” and “second” are only used to distinguish different devices and have no other meanings. Both the first device and the second device can receive a system message and resource allocation signaling that are sent by the base station in a broadcast manner. It should be understood that the first device and the second device include but are not limited to user equipment (English full name: User Equipment, English acronym: UE). It should be understood that “determine” involved in this specification may be understood as “determine”, “calculate”, “read”, “acquire”, “obtain”, or the like.

FIG. 2 is a flowchart of an embodiment of a data transmission method according to the present invention. As shown in FIG. 2, the method in this embodiment may include the following steps.

Step 101. A first device determines a frequency hopping parameter and a quantity of retransmission times of to-be-transmitted data.

The frequency hopping parameter includes an initial frequency hopping location, a bandwidth of the to-be-transmitted data, a frequency hopping offset, and a total frequency hopping bandwidth. It should be understood that when sending data, the first device needs to retransmit a same data packet for particular times. A retransmission manner may be based on chase combining (English full name: Chase Combining, English acronym: CC) or incremental redundancy (English full name: Incremental Redundancy, English acronym: IR), that is, retransmitted data packets may be exactly same content (CC) that is sent, or may be different redundancy versions (IR) in a large encoded data packet. Data packet retransmission occurs during D2D communication and scheduling assignment (English full name: Scheduling Assignment, English acronym: SA) transmission of control signaling. An objective of retransmission is to extend a coverage area of to-be-transmitted data with limited transmit power by means of retransmission for multiple times. A total quantity of retransmission times of the data packet may be: 1, 2, 4, or 8. The total quantity of retransmission times may be set by means of pre-definition, or may be configured by the base station by using signaling. In either case, there is always to-be-transmitted data that needs to be transmitted for multiple times.

In this embodiment, the first device first determines a frequency hopping parameter and a quantity of retransmission times of to-be-transmitted data that are predefined or configured by using signaling. The frequency hopping parameter includes an initial frequency hopping location, a bandwidth of the to-be-transmitted data, a frequency hopping offset, and a total frequency hopping bandwidth. All these parameters may be predefined or set by the base station by using signaling. A predefined parameter refers to a predefined parameter that is stored in the first device; and a parameter configured by using signaling may be a parameter configured by the base station in FIG. 1 for the first device in FIG. 1 by using signaling.

Step 102. The first device determines a first start location of the to-be-transmitted data according to the quantity of retransmission times of the to-be-transmitted data and the frequency hopping parameter.

In this embodiment, a frequency hopping pattern corresponding to a quantity of retransmission times needs to be designed for multiple times of retransmission of to-be-transmitted data, so as to ensure that a retransmitted data packet can traverse as many first start locations as possible, and obtain a larger frequency diversity gain. The frequency hopping pattern refers to a specific location occupied in a frequency domain during data sending. Different patterns indicate different frequency bands occupied during transmission.

Step 103. The first device sends the to-be-transmitted data to a second device according to the first start location and a bandwidth of the to-be-transmitted data.

The first device determines the first start location of the to-be-transmitted data according to the quantity of retransmission times of the to-be-transmitted data and the frequency hopping parameter, determines a frequency hopping pattern of the to-be-transmitted data according to the first start location and the bandwidth of the to-be-transmitted data, and sends, from the first start location, the to-be-transmitted data to the second device on a frequency band corresponding to the bandwidth of the to-be-transmitted data, so as to obtain a larger frequency diversity gain.

In this embodiment, the first device determines the first start location of the to-be-transmitted data according to the quantity of retransmission times of the to-be-transmitted data and the frequency hopping parameter, and sends the to-be-transmitted data to the second device according to the first start location and the bandwidth of the to-be-transmitted data, so as to ensure that a transmitted data packet can traverse as many frequency domain locations as possible, and obtain a larger frequency diversity gain.

Further, the frequency hopping parameter further includes a maximum quantity of retransmission times of the to-be-transmitted data.

The following describes, in detail by using specific embodiments, the technical solution of the method embodiment shown in FIG. 2.

A concept of a time subset is first proposed. Subframes are classified into a first time subset (Set1) and a second time subset (Set2) according to a preset rule. The two time subsets may be the same or different. The Set1 and the Set2 include any one of the following time subsets: a time set including an even subframe; a time set including an odd subframe; a time set including a subframe corresponding to a subframe index when a sum of the quantity of retransmission times of the to-be-transmitted data and the subframe index is an even number; a time set including a subframe corresponding to a subframe index when a sum of the quantity of retransmission times of the to-be-transmitted data and the subframe index is an odd number; or a time set including all subframes.

For example, i indicates a subframe number, and m indicates a current quantity of retransmission times of the to-be-transmitted data. For example, the Set1 may be a time set including an even subframe, that is, if (i mod 2=0), i εSet1, and the Set2 may be a time set including an odd subframe, that is, if (i mod 2)=1, i εSet2; the Set1 may be a time set including a subframe corresponding to a subframe index when a sum of the quantity of retransmission times of the to-be-transmitted data and the subframe index is an even number, that is, if ((i+m) mod 2)=0, iεSet1, and the Set2 may be a time set including a subframe corresponding to a subframe index when a sum of the quantity of retransmission times of the to-be-transmitted data and the subframe index is an odd number, that is, if ((i+m) mod 2)=1 i εSet2; or both the Set1 and the Set2 are time sets including all subframes.

Further, the Set1 or the Set2 may be directly indicated according to specific signaling: subframes 0 to 9 are directly indicated by using a binary number of 10 bits such as [0011000110]. Subframes whose bits are 1, that is, the subframes 2, 3, 7, and 8, belong to the Set1 or the Set2, and subframes whose bits are 0 does not belong to the Set1 or the Set2.

Further, the Set1 or the Set2 may be indirectly indicated according to a specific random sequence; a random sequence whose length is N is used for indication, subframes corresponding to 1 (or +1) in the random sequence belong to the Set 1 or the Set2, and subframes corresponding to 0 (or −1) does not belong to the Set1 or the Set2.

Further, the Set 1 or the Set2 may be a time set obtained according to the quantity of retransmission times of the to-be-transmitted data, a subframe index, and the maximum if quantity of retransmission times, that is, ((m+└i/Nₘ┘) mod 2)=0, iεSet1 and if ((m+└i/Nₘ ┘) mod 2)=1, iεSet2.

### Embodiment 1

If a current retransmission subframe belongs to the first time subset, the first device determines the first start location of the to-be-transmitted data according to the initial frequency hopping location and the total frequency hopping bandwidth; or
if a current retransmission subframe belongs to the second time subset, the first device determines the first start location of the to-be-transmitted data according to the initial frequency hopping location, the bandwidth of the to-be-transmitted data, and the total frequency hopping bandwidth.

For example, the first start location of the to-be-transmitted data may be determined by using an algorithm in formula (1):

$${n}_{PRB} ( i ) = \{ \begin{matrix}( {n}_{VRB , 1} ) mod ( {N}_{RB}^{D 2 D} ) & i ∈ Set 1 \\ ( {N}_{RB}^{D 2 D} - 1 - {n}_{VRB , 2} - {N}_{D 2 D - Tx \_ BW} ) mod ( {N}_{RB}^{D 2 D} ) & i ∈ Set 2\end{matrix} , \qquad ( 1 )$$

where
n_{VRB,1} and n_{VRB,2} respectively indicate start locations of the to-be-transmitted data in a low frequency band and a high frequency band that are of a frequency domain, and may be determined by using the initial frequency hopping location or directly indicated by the initial frequency hopping location. Typical values of n_{VRB,1} and n_{VRB,2} may be n_{VRB,1}=n_{VRB,2}=n_{VRB}, where n_{VRB} is predefined or configured by using signaling;
N_{RB}^{D2D} may indicate two values: One is a value of a total system bandwidth configured for an uplink (frequency division duplex (English full name: Frequency Division Duplex, English acronym: FDD)) or an uplink/downlink (time division duplex (English full name: Time Division Duplex, English acronym: TDD)) system in a cellular network; and the other is a dedicated bandwidth configured for use during data transmission in D2D communication, for example, 30 physical resource blocks (English full name: Physical Resource Block, English acronym: PRB), where the dedicated bandwidth is directly configured by the base station by using signaling, or obtained by means of calculation according to a related parameter configured by the base station, or predefined;
N_{D2D-Tx}_{_}_{BW} indicates the bandwidth of the to-be-transmitted data, for example, two PRBs;
i indicates a subframe number, and the Set1 and the Set2 are the foregoing first time subset and second time subset; and
n_{PRB}(i) indicates a first start location that is of the to-be-transmitted data and determined in the i^{th} subframe, and when a sum of n_{PRB}(i) and N_{D2D-Tx}_{_}_{BW} is greater than N_{RB}^{D2D}, remaining to-be-transmitted data is placed starting from a location in which an index value is 0.

It should be noted that formula (1) is an implementation manner of this embodiment. Subframes are classified into two types, the Set1 and the Set2, in formula (1), and there is a corresponding method for calculating a first start location for each time subset. Further, the subframes may not be classified, that is, for any subframe, both a calculation method corresponding to the Set1 in formula (1) and a calculation method corresponding to the Set2 in formula (1) may be used to determine the first start location of the to-be-transmitted data.

### Embodiment 2

If a current retransmission subframe belongs to the first time subset, the first device determines the first start location of the to-be-transmitted data from a relatively low frequency location to a relatively high frequency location according to the initial frequency hopping location, the bandwidth of the to-be-transmitted data, the total frequency hopping bandwidth, and a product of the quantity of retransmission times and the frequency hopping offset; or
if a current retransmission subframe belongs to a second time subset, the first device determines the first start location of the to-be-transmitted data from a relatively high frequency location to a relatively low frequency location according to the initial frequency hopping location, the bandwidth of the to-be-transmitted data, the total frequency hopping bandwidth, and a product of the quantity of retransmission times and the frequency hopping offset.

For example, the first start location of the to-be-transmitted data may be determined by using an algorithm in formula (2):

$${n}_{PRB} ( i ) = \{ \begin{matrix}( {n}_{VRB , 1} + {mN}_{offset} ) mod ( {N}_{RB}^{D 2 D} ) & i ∈ Set 1 \\ ( \begin{matrix}{N}_{RB}^{D 2 D} - 1 - {n}_{VRB , 2} - \\ {N}_{D 2 D - Tx \_ BW} - {mN}_{offset}\end{matrix} ) mod ( {N}_{RB}^{D 2 D} ) & i ∈ Set 2\end{matrix} , \qquad ( 2 )$$

where
m indicates a current quantity of retransmission times of the to-be-transmitted data, a value of m may be 0 to Nₘ−1, and Nₘ is a maximum quantity of retransmission times of the to-be-transmitted data (all maximum quantities of retransmission times in the present invention include first-time transmission); for example, Nₘ=4 indicates that one piece of to-be-transmitted data may be transmitted for at most 4 times including first-time transmission; and
N_{offset} indicates a frequency hopping offset, which is a fixed value during multiple times of retransmission of one piece of to-be-transmitted data; however, for different pieces of to-be-transmitted data, values of N_{offset} may be mutually different; the value may be configured by using signaling or may be predefined; and a pre-definition manner may include: N_{offset}=┌N_{RB}^{D2D}/Nₘ┐, N_{offset}=└N_{RB}^{D2D}/Nₘ┘, N_{offset}=┌2N_{RB}^{D2D}/Nₘ┐, or N_{offset}=└2N_{RB}^{D2D}/Nₘ┘, where └ ┘ indicates rounding down, and ┌ ┐ indicates rounding up. For other parameters, reference may be made to the description of parameters in Embodiment 1, and details are not described herein.

For another example, the first start location of the to-be-transmitted data may be determined by using an algorithm in formula (3):

$${n}_{PRB} ( i ) = \{ \begin{matrix}( {n}_{VRB , 1} + ⌈ m / 2 ⌉ {N}_{offset} ) mod ( {N}_{RB}^{D 2 D} ) & i ∈ Set 1 \\ ( \begin{matrix}{N}_{RB}^{D 2 D} - 1 - {n}_{VRB , 2} - \\ {N}_{D 2 D - Tx \_ BW} - ⌈ m / 2 ⌉ {N}_{offset}\end{matrix} ) mod ( {N}_{RB}^{D 2 D} ) & i ∈ Set 2\end{matrix} \qquad ( 3 )$$

For parameters in formula (3), reference may be made to the description of parameters in Embodiment 1 and formula (2), and details are not described herein.

According to formula (2) and formula (3), in the first time subset, different pieces of to-be-transmitted data are sequentially placed from the configured initial frequency hopping location to a high frequency location in the frequency domain by using frequency hopping offsets corresponding to the different pieces of to-be-transmitted data as steps; and in the second time subset, different pieces of to-be-transmitted data are sequentially placed from the configured initial frequency hopping location to a low-frequency location in the frequency domain by using frequency hopping offsets corresponding to the different pieces of to-be-transmitted data as steps.

It should be noted that, formula (2) and formula (3) are implementation manners of this embodiment. Subframes are classified into two types, the Set1 and the Set2, in formula (2) and formula (3), and the first start location is calculated by using calculation formulas corresponding to the Set1 and the Set2. Further, the subframes may not be classified, that is, for any subframe, either of a calculation method corresponding to the Set1 in formula (2) or formula (3) or a calculation method corresponding to the Set2 in formula (2) or formula (3) can be used to determine the first start location of the to-be-transmitted data, which is not specifically limited herein in the present invention.

For still another example, the first start location of the to-be-transmitted data may be determined by using an algorithm in formula (4):

n̅_{PRB}=(n_{VRB}+mN_{offset})mod(N_{RB}^{D2D}) (4)

For parameters in formula (4), reference may be made to the description of parameters in Embodiment 1 and formula (2), and details are not described herein.

In the algorithm of formula (4), an offset value that is multiplied by a quantity of retransmission times is sequentially added to configured start locations used during different times of retransmission, and in formula (4), the first start location is unrelated to a subframe number.

Formula (2) is used as an example, and a list of specific first start locations in Embodiments 2 is provided, where
it is assumed that N_{RB}^{D2D}=32PRB, n_{VRB,1}=n_{VRB,2}=n_{VRB}=4PRB, N_{D2D-Tx}_{_}_{BW}=6PRB, Nₘ=8, and N_{offset}=4.

TABLE 1
First start locations (PRB) corresponding to different
current quantities of retransmission times.

| | Current quantities of retransmission times | | | | | | | |
|---|---|---|---|---|---|---|---|---|
| | 0 | 1 | 2 | 3 | 4 | 5 | 6 | 7 |
| First start locations in Set1 | 4 | 8 | 12 | 16 | 20 | 24 | 28 | 0 |
| First start locations in Set2 | 21 | 17 | 13 | 9 | 5 | 1 | 29 | 25 |

As shown in Table 1, in the method in this embodiment, different times of retransmission of the to-be-transmitted data can evenly traverse all sub-bands in all 32 PRBs of the total frequency hopping bandwidth.

### Embodiment 3

If the maximum quantity of retransmission times is not greater than 2 and a current retransmission subframe belongs to the first time subset, the first device determines the first start location according to the initial frequency hopping location and the total frequency hopping bandwidth; or
if the maximum quantity of retransmission times is not greater than 2 and a current retransmission subframe belongs to the second time subset, the first device determines the first start location according to the initial frequency hopping location, the bandwidth of the to-be-transmitted data, and the total frequency hopping bandwidth; or
if the maximum quantity of retransmission times is greater than 2 and a current retransmission subframe belongs to the first time subset, the first device determines the first start location from a relatively low frequency location to a relatively high frequency location according to the initial frequency hopping location, the bandwidth of the to-be-transmitted data, the total frequency hopping bandwidth, and a product of the quantity of retransmission times and the frequency hopping offset; or
if the maximum quantity of retransmission times is greater than 2 and a current retransmission subframe belongs to the second time subset, the first device determines the first start location from a relatively high frequency location to a relatively low frequency location according to the initial frequency hopping location, the bandwidth of the to-be-transmitted data, the total frequency hopping bandwidth, and a product of the quantity of retransmission times and the frequency hopping offset.

For example, when the maximum quantity Nₘ of retransmission times is 1 or 2, the first start location of the to-be-transmitted data may be determined by using the algorithm in the foregoing formula (1); or when the maximum quantity Nₘ of retransmission times is greater than 2, the first start location of the to-be-transmitted data may be determined by using the algorithm in the foregoing formula (2) or formula (3).

Optionally, in this embodiment, when the maximum quantity Nₘ of retransmission times is greater than 2, the first start location of the to-be-transmitted data may further be determined by using the algorithm in the foregoing formula (4).

### Embodiment 4

The first device determines the first start location based on an existing formula for calculating a frequency hopping frequency domain location and according to the initial frequency hopping location, the bandwidth of the to-be-transmitted data, the total frequency hopping bandwidth, and a product of the quantity of retransmission times and the frequency hopping offset.

The first start location of the to-be-transmitted data may be determined by using an algorithm in formula (5):

n_{PRB}(i)%=(n_{VRB}%+ƒₕₒₚ(i)·N_{RB}^{sb}+((N_{RB}^{sb}−1)−2(n_{VRB}% mod N_{RB}^{sb}))·ƒₘ(i)+m·N_{offset})mod(N_{RB}^{sb}·N_{sb}) (5),

where
n_{PRB}% (i) indicates a first start location that is of the to-be-transmitted data and determined in the i^{th} subframe;
n_{VRB}% indicates a value obtained by mapping the initial frequency hopping location n_{VRB} indicated by using signaling;
ƒₕₒₚ(i) indicates a frequency hopping function in the i^{th} subframe;
ƒₘ(i) indicates a mirror function in the i^{th} subframe;
N_{RB}^{sb} indicates a size of a sub-band used during frequency hopping; and
m indicates a current quantity of retransmission times of the to-be-transmitted data, a value of m may be 0 to Nₘ−1, and Nₘ is a maximum quantity of retransmission times of the to-be-transmitted data (all maximum quantities of retransmission times in the present invention include first-time transmission); for example, Nₘ=4 indicates that one piece of to-be-transmitted data may be transmitted for at most 4 times including first-time transmission; and
N_{offset} indicates a frequency hopping offset, which is a fixed value during multiple times of retransmission of one piece of to-be-transmitted data; however, for different pieces of to-be-transmitted data, values of N_{offset} may be mutually different; the value may be configured by using signaling or may be predefined; and a pre-definition manner may include N_{offset}=┌N_{RB}^{D2D}/Nₘ┐, N_{offset}=┌N_{RB}^{D2D}/Nₘ┐, N_{offset}=┌2N_{RB}^{D2D}/Nₘ┐, or N_{offset}=└2N_{RB}^{D2D}/Nₘ┘.

Based on the existing formula for calculating a frequency hopping frequency domain location, in formula (5), the first start location of the to-be-transmitted data is generated with reference to the frequency hopping function ƒₕₒₚ(i) in the i^{th} subframe, the mirror function ƒₘ(i) in the i^{th} subframe, and the frequency hopping N_{offset} multiplied by m, so that one piece of to-be-transmitted data can traverse as many frequency domain locations as possible on a bandwidth during different times of retransmission, and as large a frequency diversity gain as possible is obtained.

### Embodiment 5

The first device obtains a frequency hopping function according to the quantity of retransmission times, where the frequency hopping function is a calculation factor in an existing formula for calculating a first initial frequency hopping location; and
the first device determines the first start location according to the frequency hopping function, the frequency hopping parameter, and a product of the quantity of retransmission times and the frequency hopping offset.

A specific method for implementing that the first device obtains the frequency hopping function according to the quantity of retransmission times may be: the first device generates a random sequence in the frequency hopping function according to the quantity of retransmission times, so as to obtain the frequency hopping function corresponding to the quantity of retransmission times.

In a formula for generating the frequency hopping function ƒₕₒₚ(i), a random seed related to the quantity of retransmission times is used when the random sequence c(k) is being generated. A fixed initial seed Cᵢₙᵢₜ is used in the prior art, and Cᵢₙᵢₜ is a cell identifier. In this embodiment, Cᵢₙᵢₜ is changed, and Cᵢₙᵢₜ=g(m,N_{ID}). For example Cᵢₙᵢₜ=m×N_{ID}, or Cᵢₙᵢₜ=m+N_{ID}, where N_{ID} indicates a fixed identifier, which may be a synchronization source identifier, a part of a synchronization source identifier, a physical cell identifier, or the like. The improved frequency hopping function is corresponding to the quantity of retransmission times and is applied in formula (5), so that one piece of to-be-transmitted data can traverse as many first start locations as possible on a bandwidth during different times of retransmission, and as large a frequency diversity gain as possible is obtained.

A specific method for implementing that the first device obtains the frequency hopping function according to the quantity of retransmission times may further be: the first device generates, according to the quantity of retransmission times, a location in which a random sequence in the frequency hopping function is read, so as to obtain the frequency hopping function corresponding to the quantity of retransmission times.

In the formula for generating the frequency hopping function ƒₕₒₚ(i), the random sequence is generated by using a same random seed, but locations in which the random sequence is read are different for different quantities of retransmission times, that is, i in the frequency hopping function ƒₕₒₚ(i) is replaced and modified by a function related to m, for example, i=(i+a)×(m+1), i=i×(m+1), or i=i×(a×m+1), where a is a constant, or a start-stop value of a value of k is generated according to m. The improved frequency hopping function is corresponding to the quantity of retransmission times and is applied in formula (5), so that one piece of to-be-transmitted data can traverse as many frequency domain locations as possible on a bandwidth during different times of retransmission, and as large a frequency diversity gain as possible is obtained.

According to the two improvements of the frequency hopping function ƒₕₒₚ(i), different random sequence values may be generated for different quantities of retransmission times, so that when the frequency hopping function ƒₕₒₚ(i) is generated, different random locations can be generated for different quantities of retransmission times.

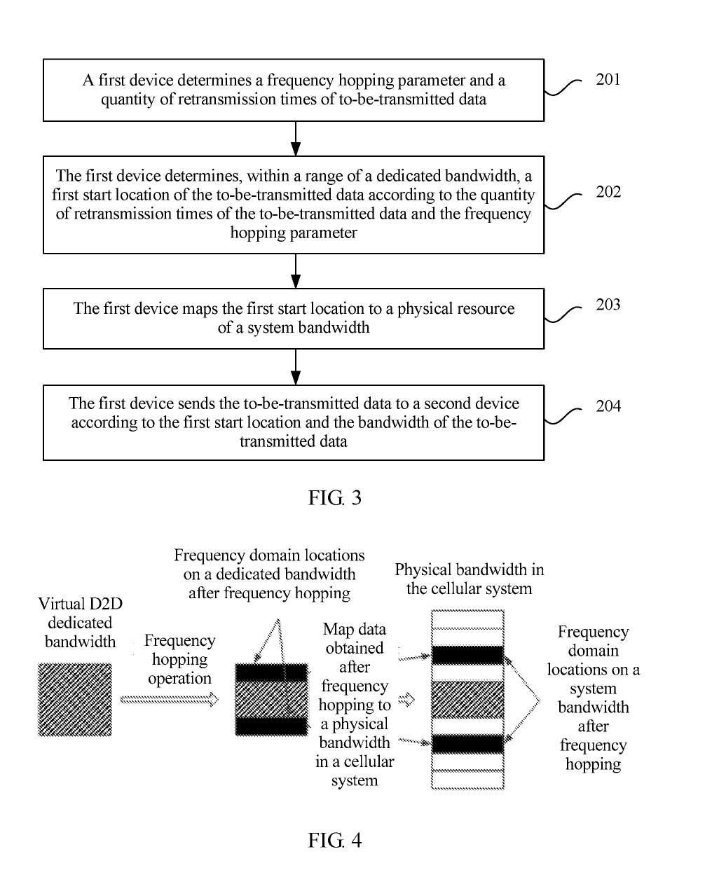

FIG. 3 is a flowchart of another embodiment of a data transmission method according to the present invention. As shown in FIG. 3, the method in this embodiment may include the following steps.

Step 201. A first device determines a frequency hopping parameter and a quantity of retransmission times of to-be-transmitted data.

Step 201 in this embodiment is similar to step 101 in the foregoing method embodiment, and details are not described herein.

Step 202. The first device determines, within a range of a dedicated bandwidth, a first start location of the to-be-transmitted data according to the quantity of retransmission times of the to-be-transmitted data and the frequency hopping parameter.

The dedicated bandwidth is a bandwidth used during data transmission from the first device to a second device. When allocating a resource, a base station sends, in a system information block (English full name: System Information Block, English acronym: SIB) message or a cell-specific radio resource control (English full name: Radio Resource Control, English acronym: RRC) message, a bandwidth specially allocated for use in D2D communication, to all devices connected to the base station. Then, in downlink control information (English full name: Downlink Control Information, English acronym: DCI) of the base station, resource allocation information of the device may be indicated by using a total bandwidth of a cellular system, or resource allocation information of the device may be indicated by using a dedicated bandwidth. That is, a resource allocation process is: a part of the bandwidth is spared as a D2D dedicated bandwidth, and frequency hopping can be performed only in this bandwidth, and a formula for calculating the first start location is executed based on a logical serial number on the D2D dedicated bandwidth. The base station notifies, in the SIB message or the cell-specific RRC message, the first device and/or the second device of a size of the dedicated bandwidth in advance.

Step 203. The first device maps the first start location to a physical resource of a system bandwidth.

The first device maps the first start location to a physical bandwidth of the system bandwidth. A mapping method may be one-by-one mapping according to a sequence of locations of the dedicated bandwidth on the system bandwidth.

Step 204. The first device sends the to-be-transmitted data to a second device according to the first start location and the bandwidth of the to-be-transmitted data.

In this embodiment, the first start location of the to-be-transmitted data is obtained on the dedicated bandwidth, so that signaling overheads of DCI and SA can be reduced, a bandwidth fragmentation problem can be mitigated, and a frequency diversity gain can be improved as much as possible.

Further, after step 201, the foregoing method further includes: sending, by the first device within the range of the dedicated bandwidth, signaling used to indicate the initial frequency hopping location to the second device.

FIG. 4 is a schematic diagram of frequency domain resource mapping. As shown in the leftmost diagram of FIG. 4, the first device combines all obtained D2D dedicated bandwidths into a continuous virtual D2D dedicated bandwidth. Then the first device performs a frequency hopping operation on the continuous virtual D2D dedicated bandwidth, and obtains, by means of calculation, frequency domain locations on the virtual D2D dedicated bandwidth after frequency hopping, as shown in black parts of the second diagram in FIG. 4. Then the virtual D2D dedicated bandwidth is one-one mapped to a physical resource, in a cellular system, that is corresponding to a D2D dedicated bandwidth and preserved for D2D. Correspondingly, as shown in the rightmost diagram of FIG. 4, data obtained after D2D frequency hopping is also carried in a frequency domain location of a corresponding physical bandwidth. This embodiment is implemented on the premise that when allocating a resource, a base station sends, in an SIB message or a cell-specific RRC message, a bandwidth specially allocated for use in D2D communication, to all devices (including the first device and the second device) connected to the base station. Therefore, the first device knows how to perform mapping from the D2D dedicated bandwidth to a corresponding frequency domain resource of a physical bandwidth in a cellular system; and after receiving a resource allocation message that is sent by the first device and indicated by using SA signaling on the D2D dedicated bandwidth, the second device can obtain a resource corresponding to the D2D dedicated bandwidth from a corresponding physical bandwidth in the cellular system, and obtain frequency domain location information of to-be-received D2D data.

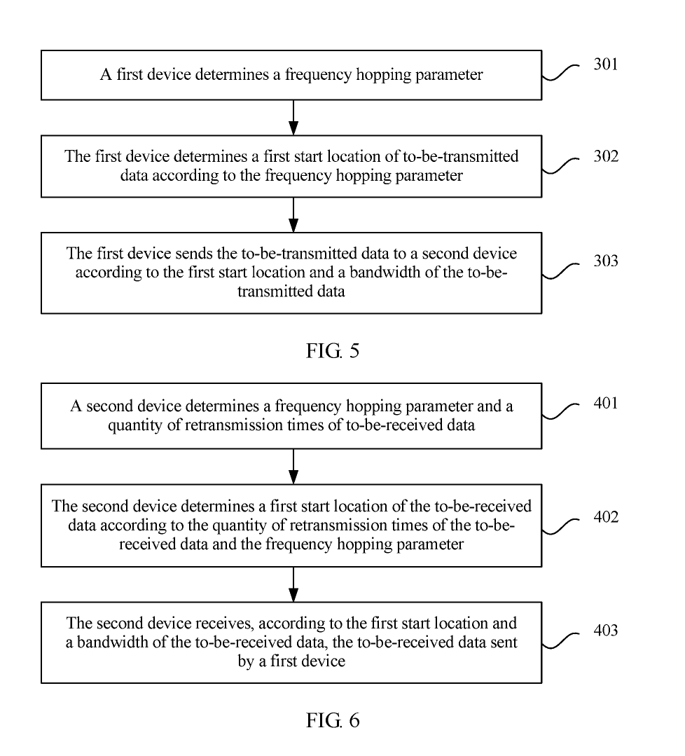

FIG. 5 is a flowchart of still another embodiment of a data transmission method according to the present invention. As shown in FIG. 5, the method in this embodiment may include the following steps.

Step 301. A first device determines a frequency hopping parameter.

The frequency hopping parameter includes an initial frequency hopping location, a bandwidth of to-be-transmitted data, and a total frequency hopping bandwidth. A difference between step 301 and step 101 of the foregoing method embodiment lies in that the first device does not need to determine a quantity of retransmission times of the to-be-transmitted data.

Step 302. The first device determines a first start location of the to-be-transmitted data according to the frequency hopping parameter.

As shown in the foregoing formula (1), a difference between step 302 and step 102 of the foregoing method embodiment lies in that the first start location of the to-be-transmitted data may be determined according to only the frequency hopping parameter.

Step 303. The first device sends the to-be-transmitted data to a second device according to the first start location and a bandwidth of the to-be-transmitted data.

Step 303 is similar to step 103 in the foregoing method embodiment, and details are not described herein.

In this embodiment, the first device determines the first start location of the to-be-transmitted data according to the frequency hopping parameter, and sends the to-be-transmitted data to the second device according to the first start location and the bandwidth of the to-be-transmitted data, so as to ensure that a transmitted data packet can traverse as many frequency domain locations as possible, and obtain a larger frequency diversity gain.

Further, a specific method for implementing step 302 may be: if a current retransmission subframe belongs to a first time subset, the first device determines the first start location of the to-be-transmitted data according to the initial frequency hopping location and the total frequency hopping bandwidth; or if a current retransmission subframe belongs to a second time subset, the first device determines the first start location of the to-be-transmitted data according to the initial frequency hopping location, the bandwidth of the to-be-transmitted data, and the total frequency hopping bandwidth.

Further, a specific method for implementing step 302 may be: the first device determines whether the maximum quantity of retransmission times is not greater than 2; and if the maximum quantity of retransmission times is not greater than 2 and a current retransmission subframe belongs to a first time subset, the first device determines the first start location according to the initial frequency hopping location and the total frequency hopping bandwidth; or if the maximum quantity of retransmission times is not greater than 2 and a current retransmission subframe belongs to a second time subset, the first device determines the first start location according to the initial frequency hopping location, the bandwidth of the to-be-transmitted data, and the total frequency hopping bandwidth.

FIG. 6 is a flowchart of yet another embodiment of a data transmission method according to the present invention. As shown in FIG. 6, the method in this embodiment may include the following steps.

Step 401. A second device determines a frequency hopping parameter and a quantity of retransmission times of to-be-received data.

The frequency hopping parameter includes an initial frequency hopping location, a bandwidth of the to-be-received data, a frequency hopping offset, and a total frequency hopping bandwidth. This embodiment is executed by the second device, and is corresponding to the method embodiment shown in FIG. 2. The frequency hopping parameter obtained by the second device may be predefined, or may be sent by the first device by using signaling.

Step 402. The second device determines a first start location of the to-be-received data according to the quantity of retransmission times of the to-be-received data and the frequency hopping parameter.

The second device needs to know the first start location of the to-be-received data to receive the data, and because frequency hopping parameters on two sides, the first device and the second device, are the same, the method used by the second device to determine the first start location is the same as that used by the first device.

Step 403. The second device receives, according to the first start location and a bandwidth of the to-be-received data, the to-be-received data sent by a first device.

In this embodiment, the second device obtains the first start location of the to-be-received data according to the quantity of retransmission times of the to-be-received data and the frequency hopping parameter, and receives the to-be-received data according to the first start location and the bandwidth of the to-be-received data, so as to ensure that a transmitted data packet can traverse as many frequency domain locations as possible, and obtain a larger frequency diversity gain.

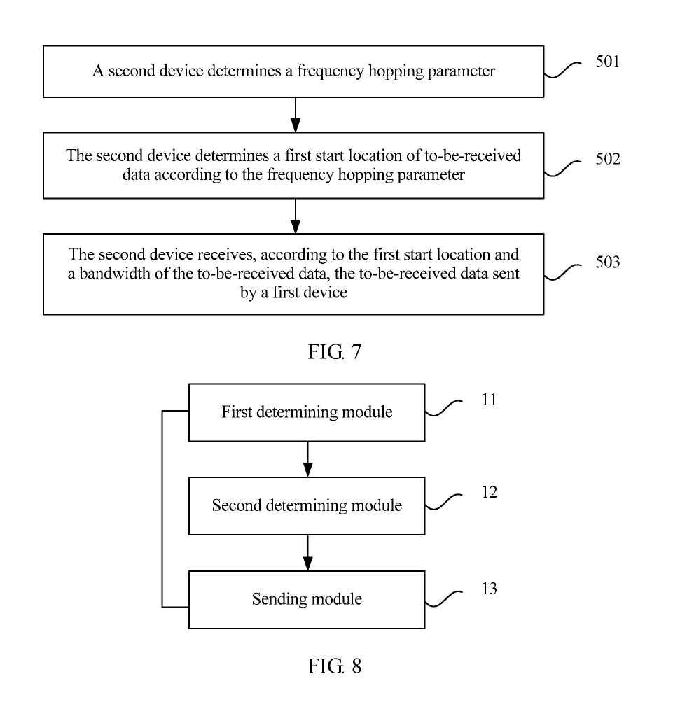

FIG. 7 is a flowchart of yet another embodiment of a data transmission method according to the present invention. As shown in FIG. 7, the method in this embodiment may include the following steps.

Step 501. The second device determines a frequency hopping parameter.

The frequency hopping parameter includes an initial frequency hopping location, a bandwidth of to-be-received data, and a total frequency hopping bandwidth. A difference between step 501 and step 401 of the foregoing method embodiment lies in that the second device does not need to determine a quantity of retransmission times of to-be-transmitted data.

Step 502. The second device determines a first start location of the to-be-received data according to the frequency hopping parameter.

As shown in the foregoing formula (1), a difference between step 502 and step 402 of the foregoing method embodiment lies in that the first start location of the to-be-received data may be determined according to only the frequency hopping parameter.

Step 503. The second device receives, according to the first start location and a bandwidth of the to-be-received data, the to-be-received data sent by a first device.

Step 503 is similar to step 403 in the foregoing method embodiment, and details are not described herein.

In this embodiment, the second device obtains the first start location of the to-be-received data according to the frequency hopping parameter, and receives the to-be-received data according to the first start location and the bandwidth of the to-be-received data, so as to ensure that a transmitted data packet can traverse as many frequency domain locations as possible, and obtain a larger frequency diversity gain.

Further, a specific method for implementing step 502 may be: if a current retransmission subframe belongs to a first time subset, the second device determines the first start location of the to-be-received data according to the initial frequency hopping location and the total frequency hopping bandwidth; or if a current retransmission subframe belongs to a second time subset, the second device determines the first start location of the to-be-received data according to the initial frequency hopping location, the bandwidth of the to-be-received data, and the total frequency hopping bandwidth.

Further, a specific method for implementing step 502 may be: the second device determines whether the maximum quantity of retransmission times is not greater than 2; and if the maximum quantity of retransmission times is not greater than 2 and a current retransmission subframe belongs to a first time subset, the second device determines the first start location according to the initial frequency hopping location and the total frequency hopping bandwidth; or if the maximum quantity of retransmission times is not greater than 2 and a current retransmission subframe belongs to a second time subset, the second device determines the first start location according to the initial frequency hopping location, the bandwidth of the to-be-received data, and the total frequency hopping bandwidth.

In this embodiment, a method used by the second device to determine the first start location of the to-be-received data may also be any method described in the foregoing Embodiment 1 to Embodiment 5, and details are not described herein.

FIG. 8 is a schematic structural diagram of an embodiment of a device according to the present invention. As shown in FIG. 8, the device in this embodiment may include: a first determining module 11, a second determining module 12, and a sending module 13. The first determining module 11 is configured to determine a frequency hopping parameter and a quantity of retransmission times of to-be-transmitted data, where the frequency hopping parameter includes an initial frequency hopping location, a bandwidth of the to-be-transmitted data, a frequency hopping offset, and a total frequency hopping bandwidth. The second determining module 12 is configured to determine a first start location of the to-be-transmitted data according to the quantity of retransmission times of the to-be-transmitted data and the frequency hopping parameter. The sending module 13 is configured to send the to-be-transmitted data to a second device according to the first start location and the bandwidth of the to-be-transmitted data.

The device in this embodiment is equivalent to the foregoing first device, and may be configured to execute the technical solutions of the method embodiment shown in FIG. 2 or FIG. 3, and an implementation principle and a technical effect of the device are similar and are not described herein again.

In addition, a computer readable medium is further provided, including a computer readable instruction that performs the following operation when the instruction is executed: executing the operations from 101 to 103 in the method of the foregoing embodiment. Optionally, the computer readable instruction may further execute the operations from 201 to 204 in the method of the foregoing embodiment.

In addition, a computer program product is further provided, including the foregoing computer readable medium.

Further, the frequency hopping parameter further includes a maximum quantity of retransmission times of the to-be-transmitted data.

Further, the second determining module 12 is specifically configured to: if a current retransmission subframe belongs to a first time subset, determine the first start location of the to-be-transmitted data from a relatively low frequency location to a relatively high frequency location according to the initial frequency hopping location, the bandwidth of the to-be-transmitted data, the total frequency hopping bandwidth, and a product of the quantity of retransmission times and the frequency hopping offset; or if a current retransmission subframe belongs to a second time subset, determine the first start location of the to-be-transmitted data from a relatively high frequency location to a relatively low frequency location according to the initial frequency hopping location, the bandwidth of the to-be-transmitted data, the total frequency hopping bandwidth, and a product of the quantity of retransmission times and the frequency hopping offset.

Further, the first time subset and the second time subset are the same or different.

Further, the first time subset and the second time subset include any one of the following time subsets:
a time set including an even subframe;
a time set including an odd subframe;
a time set including a subframe corresponding to a subframe index when a sum of the quantity of retransmission times of the to-be-transmitted data and the subframe index is an even number;
a time set including a subframe corresponding to a subframe index when a sum of the quantity of retransmission times of the to-be-transmitted data and the subframe index is an odd number; or
a time set including all subframes.

Further, the second determining module 12 is specifically configured to determine the first start location based on an existing formula for calculating a frequency hopping frequency domain location and according to the initial frequency hopping location, the bandwidth of the to-be-transmitted data, the total frequency hopping bandwidth, and a product of the quantity of retransmission times and the frequency hopping offset.

Further, the second determining module 12 is specifically configured to: obtain a frequency hopping function according to the quantity of retransmission times, where the frequency hopping function is a calculation factor in an existing formula for calculating a frequency hopping frequency domain location; and determine the first start location according to the frequency hopping function, the frequency hopping parameter, and a product of the quantity of retransmission times and the frequency hopping offset.

Further, the second determining module 12 is further configured to: generate a random sequence in the frequency hopping function according to the quantity of retransmission times, so as to obtain the frequency hopping function corresponding to the quantity of retransmission times; or generate, according to the quantity of retransmission times, a location in which a random sequence in the frequency hopping function is read, so as to obtain the frequency hopping function corresponding to the quantity of retransmission times.

Further, the total frequency hopping bandwidth is a dedicated bandwidth used during data transmission, and the second determining module 12 is specifically configured to determine, within a range of the dedicated bandwidth, the first start location of the to-be-transmitted data according to the quantity of retransmission times of the to-be-transmitted data and the frequency hopping parameter, and map the first start location to a physical resource of a system bandwidth.

Further, the sending module 13 is further configured to send, within the range of the dedicated bandwidth, signaling used to indicate the initial frequency hopping location to the second device.

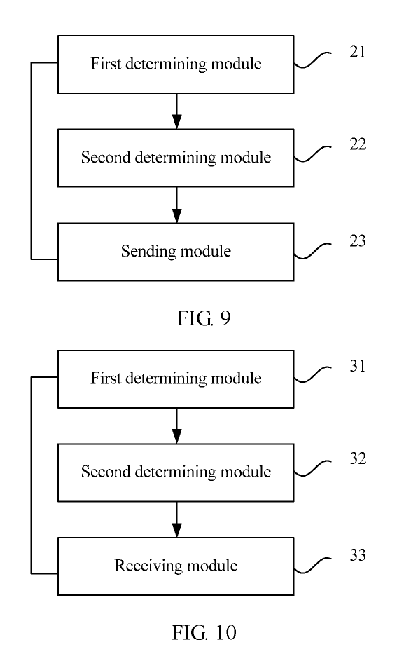

FIG. 9 is a schematic structural diagram of an embodiment of a device according to the present invention. As shown in FIG. 9, the device in this embodiment may include: a first determining module 21, a second determining module 22, and a sending module 23. The first determining module 21 is configured to determine a frequency hopping parameter, where the frequency hopping parameter includes an initial frequency hopping location, a bandwidth of to-be-transmitted data, and a total frequency hopping bandwidth. The second determining module 22 is configured to determine a first start location of the to-be-transmitted data according to the frequency hopping parameter. The sending module 23 is configured to send the to-be-transmitted data to a second device according to the first start location and the bandwidth of the to-be-transmitted data.

The device in this embodiment is equivalent to the foregoing first device, and may be configured to execute the technical solutions of the method embodiment shown in FIG. 5, and an implementation principle and a technical effect of the device are similar and are not described herein again.

In addition, a computer readable medium is further provided, including a computer readable instruction that performs the following operation when the instruction is executed: executing the operations from 301 to 303 in the method of the foregoing embodiment.

In addition, a computer program product is further provided, including the foregoing computer readable medium.

Further, the second determining module 22 is specifically configured to: if a current retransmission subframe belongs to a first time subset, determine the first start location of the to-be-transmitted data according to the initial frequency hopping location and the total frequency hopping bandwidth; or if a current retransmission subframe belongs to a second time subset, determine the first start location of the to-be-transmitted data according to the initial frequency hopping location, the bandwidth of the to-be-received data, and the total frequency hopping bandwidth.

Further, the second determining module 22 is specifically configured to: determine whether the maximum quantity of retransmission times is not greater than 2; and if the maximum quantity of retransmission times is not greater than 2 and a current retransmission subframe belongs to a first time subset, determine the first start location according to the initial frequency hopping location and the total frequency hopping bandwidth, or if the maximum quantity of retransmission times is not greater than 2 and a current retransmission subframe belongs to a second time subset, determine the first start location according to the initial frequency hopping location, the bandwidth of the to-be-transmitted data, and the total frequency hopping bandwidth.

Further, the total frequency hopping bandwidth is a dedicated bandwidth used during data transmission, and the second determining module 22 is specifically configured to determine, within a range of the dedicated bandwidth, the first start location of the to-be-transmitted data according to the frequency hopping parameter, and map the first start location to a physical resource of a system bandwidth.

Further, the sending module 23 is further configured to send, within the range of the dedicated bandwidth, signaling used to indicate the initial frequency hopping location to the second device.

FIG. 10 is a schematic structural diagram of an embodiment of a device according to the present invention. As shown in FIG. 10, the device in this embodiment may include: a first determining module 31, a second determining module 32, and a receiving module 33. The first determining module 31 is configured to determine a frequency hopping parameter and a quantity of retransmission times of to-be-received data, where the frequency hopping parameter includes an initial frequency hopping location, a bandwidth of the to-be-received data, a frequency hopping offset, and a total frequency hopping bandwidth. The second determining module 32 is configured to determine a first start location of the to-be-received data according to the quantity of retransmission times of the to-be-received data and the frequency hopping parameter. The receiving module 33 is configured to receive, according to the first start location and the bandwidth of the to-be-received data, the to-be-received data sent by a first device.

The device in this embodiment is equivalent to the foregoing second device, and may be configured to execute the technical solutions of the method embodiment shown in FIG. 6, and an implementation principle and a technical effect of the device are similar and are not described herein again.

In addition, a computer readable medium is further provided, including a computer readable instruction that performs the following operation when the instruction is executed: executing the operations from 401 to 403 in the method of the foregoing embodiment.

In addition, a computer program product is further provided, including the foregoing computer readable medium.

Further, the frequency hopping parameter further includes a maximum quantity of retransmission times of the to-be-received data and a frequency hopping offset.

Further, the second determining module 32 is specifically configured to: if a current retransmission subframe belongs to a first time subset, determine the first start location of the to-be-received data from a relatively low frequency location to a relatively high frequency location according to the initial frequency hopping location, the bandwidth of the to-be-received data, the total frequency hopping bandwidth, and a product of the quantity of retransmission times and the frequency hopping offset; or if a current retransmission subframe belongs to a second time subset, determine the first start location of the to-be-received data from a relatively high frequency location to a relatively low frequency location according to the initial frequency hopping location, the bandwidth of the to-be-received data, the total frequency hopping bandwidth, and a product of the quantity of retransmission times and the frequency hopping offset.

Further, the first time subset and the second time subset are the same or different.

Further, the first time subset and the second time subset include any one of the following time subsets:
a time set including an even subframe;
a time set including an odd subframe;
a time set including a subframe corresponding to a subframe index when a sum of the quantity of retransmission times of the to-be-received data and the subframe index is an even number;
a time set including a subframe corresponding to a subframe index when a sum of the quantity of retransmission times of the to-be-received data and the subframe index is an odd number; or
a time set including all subframes.

Further, the second determining module 32 is specifically configured to determine the first start location based on an existing formula for calculating a frequency hopping frequency domain location and according to the initial frequency hopping location, the bandwidth of the to-be-received data, the total frequency hopping bandwidth, and a product of the quantity of retransmission times and the frequency hopping offset.

Further, the second determining module 32 is specifically configured to: obtain a frequency hopping function according to the quantity of retransmission times, where the frequency hopping function is a calculation factor in an existing formula for calculating a frequency hopping frequency domain location; and determine the first start location according to the frequency hopping function, the frequency hopping parameter, and a product of the quantity of retransmission times and the frequency hopping offset.

Further, the second determining module 32 is further configured to: generate a random sequence in the frequency hopping function according to the quantity of retransmission times, so as to obtain the frequency hopping function corresponding to the quantity of retransmission times; or generate, according to the quantity of retransmission times, a location in which a random sequence in the frequency hopping function is read, so as to obtain the frequency hopping function corresponding to the quantity of retransmission times.

Further, the total frequency hopping bandwidth is a dedicated bandwidth used during data transmission, and the second determining module 32 is specifically configured to determine, within a range of the dedicated bandwidth, the first start location of the to-be-received data according to the quantity of retransmission times of the to-be-received data and the frequency hopping parameter, and map the first start location to a physical resource of a system bandwidth.

Further, the receiving module 33 is further configured to receive, within the range of the dedicated bandwidth, signaling used to indicate the initial frequency hopping location.

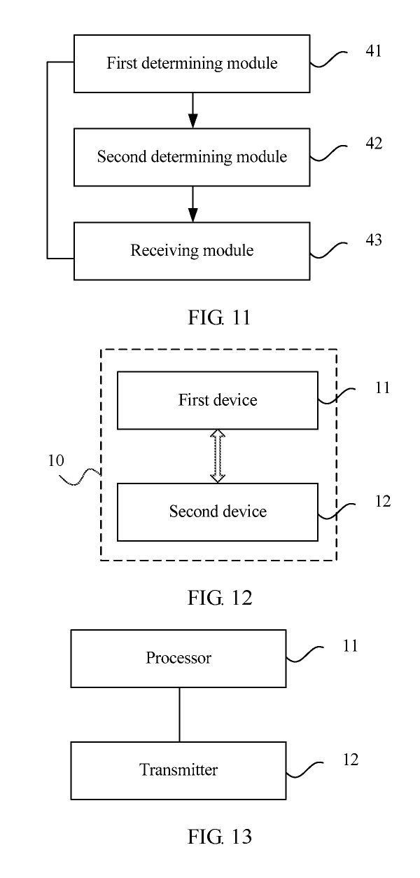

FIG. 11 is a schematic structural diagram of an embodiment of a device according to the present invention. As shown in FIG. 11, the device in this embodiment may include: a first determining module 41, a second determining module 42, and a receiving module 43. The first determining module 41 is configured to determine a frequency hopping parameter, where the frequency hopping parameter includes an initial frequency hopping location, a bandwidth of to-be-received data, and a total frequency hopping bandwidth. The second determining module 42 is configured to determine a first start location of the to-be-received data according to the frequency hopping parameter. The receiving module 43 is configured to receive, according to the first start location and the bandwidth of the to-be-received data, the to-be-received data sent by a first device.

The device in this embodiment is equivalent to the foregoing second device, and may be configured to execute the technical solutions of the method embodiment shown in FIG. 7, and an implementation principle and a technical effect of the device are similar and are not described herein again.

In addition, a computer readable medium is further provided, including a computer readable instruction that performs the following operation when the instruction is executed: executing the operations from 501 to 503 in the method of the foregoing embodiment.

In addition, a computer program product is further provided, including the foregoing computer readable medium.

Further, the second determining module 42 is specifically configured to: if a current retransmission subframe belongs to a first time subset, determine the first start location of the to-be-received data according to the initial frequency hopping location and the total frequency hopping bandwidth; or if a current retransmission subframe belongs to a second time subset, determine the first start location of the to-be-received data according to the initial frequency hopping location, the bandwidth of the to-be-received data, and the total frequency hopping bandwidth.

Further, the frequency hopping parameter further includes a maximum quantity of retransmission times of the to-be-received data, and the second determining module 42 is specifically configured to: determine whether the maximum quantity of retransmission times is not greater than 2; and if the maximum quantity of retransmission times is not greater than 2 and a current retransmission subframe belongs to a first time subset, determine the first start location according to the initial frequency hopping location and the total frequency hopping bandwidth, or if the maximum quantity of retransmission times is not greater than 2 and a current retransmission subframe belongs to a second time subset, determine the first start location according to the initial frequency hopping location, the bandwidth of the to-be-received data, and the total frequency hopping bandwidth.

Further, the total frequency hopping bandwidth is a dedicated bandwidth used during data transmission, and the second determining module 42 is specifically configured to determine, within a range of the dedicated bandwidth, the first start location of the to-be-received data according to the frequency hopping parameter, and map the first start location to a physical resource of a system bandwidth.

Further, the receiving module 43 is further configured to receive, within the range of the dedicated bandwidth, signaling used to indicate the initial frequency hopping location.

FIG. 12 is a schematic structural diagram of an embodiment of a wireless system according to the present invention. As shown in FIG. 12, a system 10 in this embodiment includes a first device 11 and a second device 12. The first device 11 may use a structure in the device embodiment shown in FIG. 8, correspondingly, the first device 11 can execute the technical solutions in the method embodiments shown in FIG. 2 and FIG. 3, and an implementation principle and a technical effect of the first device 11 are similar and are not described herein again. The second device 12 may use a structure in the device embodiment shown in FIG. 10, correspondingly, the second device 12 can execute the technical solutions in the method embodiment shown in FIG. 6, and an implementation principle and a technical effect of the second device 12 are similar and are not described herein again. Alternatively, the first device 11 may use a structure in the device embodiment shown in FIG. 9, correspondingly, the first device 11 can execute the technical solutions in the method embodiment shown in FIG. 5, and an implementation principle and a technical effect of the first device 11 are similar and are not described herein again; and the second device 12 may use a structure in the device embodiment shown in FIG. 11, correspondingly, the second device 12 can execute the technical solutions in the method embodiment shown in FIG. 7, and an implementation principle and a technical effect of the second device 12 are similar.

FIG. 13 is a schematic structural diagram of an embodiment of a device according to the present invention. As shown in FIG. 13, the device in this embodiment may include a processor 11 and a transmitter 12. The processor 11 is configured to determine a frequency hopping parameter and a quantity of retransmission times of to-be-transmitted data, where the frequency hopping parameter includes an initial frequency hopping location, a bandwidth of the to-be-transmitted data, a frequency hopping offset, and a total frequency hopping bandwidth, and determine a first start location of the to-be-transmitted data according to the quantity of retransmission times of the to-be-transmitted data and the frequency hopping parameter. The transmitter 12 is configured to send the to-be-transmitted data to a second device according to the first start location and the bandwidth of the to-be-transmitted data.

Further, the frequency hopping parameter further includes a maximum quantity of retransmission times of the to-be-transmitted data.

Further, the processor 11 is specifically configured to: if a current retransmission subframe belongs to a first time subset, determine the first start location of the to-be-transmitted data from a relatively low frequency location to a relatively high frequency location according to the initial frequency hopping location, the bandwidth of the to-be-transmitted data, the total frequency hopping bandwidth, and a product of the quantity of retransmission times and the frequency hopping offset; or if a current retransmission subframe belongs to a second time subset, determine the first start location of the to-be-transmitted data from a relatively high frequency location to a relatively low frequency location according to the initial frequency hopping location, the bandwidth of the to-be-transmitted data, the total frequency hopping bandwidth, and a product of the quantity of retransmission times and the frequency hopping offset.

Further, the first time subset and the second time subset are the same or different.

Further, the first time subset and the second time subset include any one of the following time subsets: a time set including an even subframe; a time set including an odd subframe; a time set including a subframe corresponding to a subframe index when a sum of the quantity of retransmission times of the to-be-transmitted data and the subframe index is an even number; a time set including a subframe corresponding to a subframe index when a sum of the quantity of retransmission times of the to-be-transmitted data and the subframe index is an odd number; or a time set including all subframes.

Further, the processor 11 is specifically configured to determine the first start location based on an existing formula for calculating a frequency hopping frequency domain location and according to the initial frequency hopping location, the bandwidth of the to-be-transmitted data, the total frequency hopping bandwidth, and a product of the quantity of retransmission times and the frequency hopping offset.

Further, the processor 11 is specifically configured to: obtain a frequency hopping function according to the quantity of retransmission times, where the frequency hopping function is a calculation factor in an existing formula for calculating a frequency hopping frequency domain location; and determine the first start location according to the frequency hopping function, the frequency hopping parameter, and a product of the quantity of retransmission times and the frequency hopping offset.

Further, the processor 11 is further configured to: generate a random sequence in the frequency hopping function according to the quantity of retransmission times, so as to obtain the frequency hopping function corresponding to the quantity of retransmission times; or generate, according to the quantity of retransmission times, a location in which a random sequence in the frequency hopping function is read, so as to obtain the frequency hopping function corresponding to the quantity of retransmission times.

Further, the total frequency hopping bandwidth is a dedicated bandwidth used during data transmission, and the processor 11 is specifically configured to determine, within a range of the dedicated bandwidth, the first start location of the to-be-transmitted data according to the quantity of retransmission times of the to-be-transmitted data and the frequency hopping parameter, and map the first start location to a physical resource of a system bandwidth.

Further, the transmitter 12 is further configured to send, within the range of the dedicated bandwidth, signaling used to indicate the initial frequency hopping location to the second device.

The device shown in FIG. 13 may further be applicable to another method embodiment, that is, the processor 11 is configured to determine a frequency hopping parameter, where the frequency hopping parameter includes an initial frequency hopping location, a bandwidth of to-be-transmitted data, and a total frequency hopping bandwidth, and determine a first start location of the to-be-transmitted data according to the frequency hopping parameter; and the transmitter 12 is configured to send the to-be-transmitted data to a second device according to the first start location and the bandwidth of the to-be-transmitted data.

Further, the processor 11 is specifically configured to: if a current retransmission subframe belongs to a first time subset, determine the first start location of the to-be-transmitted data according to the initial frequency hopping location and the total frequency hopping bandwidth; or if a current retransmission subframe belongs to a second time subset, determine the first start location of the to-be-transmitted data according to the initial frequency hopping location, the bandwidth of the to-be-received data, and the total frequency hopping bandwidth.

Further, the processor 11 is specifically configured to: determine whether the maximum quantity of retransmission times is not greater than 2; and if the maximum quantity of retransmission times is not greater than 2 and a current retransmission subframe belongs to a first time subset, determine the first start location according to the initial frequency hopping location and the total frequency hopping bandwidth, or if the maximum quantity of retransmission times is not greater than 2 and a current retransmission subframe belongs to a second time subset, determine the first start location according to the initial frequency hopping location, the bandwidth of the to-be-transmitted data, and the total frequency hopping bandwidth.

Further, the total frequency hopping bandwidth is a dedicated bandwidth used during data transmission, and the processor 11 is specifically configured to determine, within a range of the dedicated bandwidth, the first start location of the to-be-transmitted data according to the frequency hopping parameter, and map the first start location to a physical resource of a system bandwidth.

Further, the transmitter 12 is further configured to send, within the range of the dedicated bandwidth, signaling used to indicate the initial frequency hopping location to the second device.

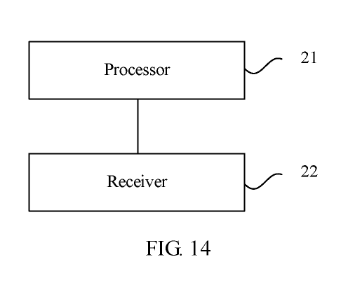

FIG. 14 is a schematic structural diagram of an embodiment of a device according to the present invention. As shown in FIG. 14, the device in this embodiment may include a processor 21 and a receiver 22. The processor 21 is configured to: determine a frequency hopping parameter and a quantity of retransmission times of to-be-received data, where the frequency hopping parameter includes an initial frequency hopping location, a bandwidth of the to-be-received data, a frequency hopping offset, and a total frequency hopping bandwidth; and determine a first start location of the to-be-received data according to the quantity of retransmission times of the to-be-received data and the frequency hopping parameter. The receiver 22 is configured to receive, according to the first start location and the bandwidth of the to-be-received data, the to-be-received data sent by a first device.

Further, the frequency hopping parameter further includes a maximum quantity of retransmission times of the to-be-received data and a frequency hopping offset.

Further, the processor 21 is specifically configured to: if a current retransmission subframe belongs to a first time subset, determine the first start location of the to-be-received data from a relatively low frequency location to a relatively high frequency location according to the initial frequency hopping location, the bandwidth of the to-be-received data, the total frequency hopping bandwidth, and a product of the quantity of retransmission times and the frequency hopping offset; or if a current retransmission subframe belongs to a second time subset, determine the first start location of the to-be-received data from a relatively high frequency location to a relatively low frequency location according to the initial frequency hopping location, the bandwidth of the to-be-received data, the total frequency hopping bandwidth, and a product of the quantity of retransmission times and the frequency hopping offset.

Further, the processor 21 is specifically configured to: determine whether the maximum quantity of retransmission times is not greater than 2; and if the maximum quantity of retransmission times is not greater than 2 and a current retransmission subframe belongs to a first time subset, determine the first start location according to the initial frequency hopping location and the total frequency hopping bandwidth; or if the maximum quantity of retransmission times is not greater than 2 and a current retransmission subframe belongs to a second time subset, determine the first start location according to the initial frequency hopping location, the bandwidth of the to-be-received data, and the total frequency hopping bandwidth; or if the maximum quantity of retransmission times is greater than 2 and a current retransmission subframe belongs to a first time subset, determine the first start location from a relatively low frequency location to a relatively high frequency location according to the initial frequency hopping location, the bandwidth of the to-be-received data, the total frequency hopping bandwidth, and a product of the quantity of retransmission times and the frequency hopping offset; or if the maximum quantity of retransmission times is greater than 2 and a current retransmission subframe belongs to a second time subset, determine the first start location from a relatively high frequency location to a relatively low frequency location according to the initial frequency hopping location, the bandwidth of the to-be-received data, the total frequency hopping bandwidth, and a product of the quantity of retransmission times and the frequency hopping offset.

Further, the first time subset and the second time subset are the same or different.

Further, the first time subset and the second time subset include any one of the following time subsets:
a time set including an even subframe;
a time set including an odd subframe;
a time set including a subframe corresponding to a subframe index when a sum of the quantity of retransmission times of the to-be-received data and the subframe index is an even number;
a time set including a subframe corresponding to a subframe index when a sum of the quantity of retransmission times of the to-be-received data and the subframe index is an odd number; or
a time set including all subframes.

Further, the processor 21 is specifically configured to determine the first start location based on an existing formula for calculating a frequency hopping frequency domain location and according to the initial frequency hopping location, the bandwidth of the to-be-received data, the total frequency hopping bandwidth, and a product of the quantity of retransmission times and the frequency hopping offset.

Further, the processor 21 is specifically configured to: obtain a frequency hopping function according to the quantity of retransmission times, where the frequency hopping function is a calculation factor in an existing formula for calculating a frequency hopping frequency domain location; and determine the first start location according to the frequency hopping function, the frequency hopping parameter, and a product of the quantity of retransmission times and the frequency hopping offset.

Further, the processor 21 is further configured to: generate a random sequence in the frequency hopping function according to the quantity of retransmission times, so as to obtain the frequency hopping function corresponding to the quantity of retransmission times; or generate, according to the quantity of retransmission times, a location in which a random sequence in the frequency hopping function is read, so as to obtain the frequency hopping function corresponding to the quantity of retransmission times.

Further, the total frequency hopping bandwidth is a dedicated bandwidth used during data transmission, and the processor 21 is specifically configured to determine, within a range of the dedicated bandwidth, the first start location of the to-be-received data according to the quantity of retransmission times of the to-be-received data and the frequency hopping parameter, and map the first start location to a physical resource of a system bandwidth.

Further, the receiving module 33 is further configured to receive, within the range of the dedicated bandwidth, signaling used to indicate the initial frequency hopping location.

The device shown in FIG. 14 may further be applicable to another method embodiment, that is, the processor 21 is configured to: determine a frequency hopping parameter, where the frequency hopping parameter includes an initial frequency hopping location, a bandwidth of to-be-received data, and a total frequency hopping bandwidth; and determine a first start location of the to-be-received data according to the frequency hopping parameter; and the receiver 22 is configured to receive, according to the first start location and the bandwidth of the to-be-received data, the to-be-received data sent by a first device.

Further, the processor 21 is specifically configured to: if a current retransmission subframe belongs to a first time subset, determine the first start location of the to-be-received data according to the initial frequency hopping location and the total frequency hopping bandwidth; or if a current retransmission subframe belongs to a second time subset, determine the first start location of the to-be-received data according to the initial frequency hopping location, the bandwidth of the to-be-received data, and the total frequency hopping bandwidth.

Further, the frequency hopping parameter further includes a maximum quantity of retransmission times of the to-be-received data, and the processor 21 is specifically configured to: determine whether the maximum quantity of retransmission times is not greater than 2; and if the maximum quantity of retransmission times is not greater than 2 and a current retransmission subframe belongs to a first time subset, determine the first start location according to the initial frequency hopping location and the total frequency hopping bandwidth, or if the maximum quantity of retransmission times is not greater than 2 and a current retransmission subframe belongs to a second time subset, determine the first start location according to the initial frequency hopping location, the bandwidth of the to-be-received data, and the total frequency hopping bandwidth.

Further, the total frequency hopping bandwidth is a dedicated bandwidth used during data transmission, and the processor 21 is specifically configured to determine, within a range of the dedicated bandwidth, the first start location of the to-be-received data according to the frequency hopping parameter, and map the first start location to a physical resource of a system bandwidth.

Further, the receiver 22 is further configured to receive, within the range of the dedicated bandwidth, signaling used to indicate the initial frequency hopping location.

In the several embodiments provided in the present invention, it should be understood that the disclosed device and method may be implemented in other manners. For example, the described device embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the devices or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) or a processor to perform a part of the steps of the methods described in the embodiments of the present invention. The foregoing storage medium includes: any medium that can store program code, such as a USB flash drive, a removable hard disk, a read-only memory (Read-Only Memory, ROM), a random access memory (Random Access Memory, RAM), a magnetic disk, or an optical disc.

It may be clearly understood by a person skilled in the art that, for the purpose of convenient and brief description, division of the foregoing function modules is taken as an example for illustration. In actual application, the foregoing functions can be allocated to different function modules and implemented according to a requirement, that is, an inner structure of an apparatus is divided into different function modules to implement all or part of the functions described above. For a detailed working process of the foregoing device, reference may be made to a corresponding process in the foregoing method embodiments, and details are not described herein again.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

What is claimed is:

1-61. (canceled)

62. A data transmission method, comprising:
determining, by a first device, a frequency hopping parameter, wherein the frequency hopping parameter comprises an initial frequency hopping location, a bandwidth of to-be-transmitted data, and a total frequency hopping bandwidth;
determining, by the first device, a first start location of the to-be-transmitted data according to the frequency hopping parameter; and
sending, by the first device, the to-be-transmitted data to a second device according to the first start location and the bandwidth of the to-be-transmitted data.

63. The method according to claim 62, wherein the determining, by the first device, a first start location of the to-be-transmitted data according to the frequency hopping parameter comprises:
if a current retransmission subframe belongs to a first time subset, determining, by the first device, the first start location of the to-be-transmitted data according to the initial frequency hopping location and the total frequency hopping bandwidth; or if a current retransmission subframe belongs to a second time subset, determining, by the first device, the first start location of the to-be-transmitted data according to the initial frequency hopping location, the bandwidth of the to-be-transmitted data, and the total frequency hopping bandwidth.

64. The method according to claim 62, wherein the frequency hopping parameter further comprises a maximum quantity of retransmission times of the to-be-transmitted data, and before the determining, by the first device, a first start location of the to-be-transmitted data according to the frequency hopping parameter, further comprises:
determining, by the first device, whether the maximum quantity of retransmission times is not greater than 2; and
the determining, by the first device, a first start location of the to-be-transmitted data according to the frequency hopping parameter comprises:
if the maximum quantity of retransmission times is not greater than 2 and a current retransmission subframe belongs to a first time subset, determining, by the first device, the first start location according to the initial frequency hopping location and the total frequency hopping bandwidth; or if the maximum quantity of retransmission times is not greater than 2 and a current retransmission subframe belongs to a second time subset, determining, by the first device, the first start location according to the initial frequency hopping location, the bandwidth of the to-be-transmitted data, and the total frequency hopping bandwidth.

65. The method according to claim 62, wherein the total frequency hopping bandwidth is a dedicated bandwidth used during data transmission from the first device to the second device, and the determining, by the first device, a first start location of the to-be-transmitted data according to the frequency hopping parameter comprises:
determining, by the first device within a range of the dedicated bandwidth, the first start location of the to-be-transmitted data according to the frequency hopping parameter; and
mapping, by the first device, the first start location to a physical resource of a system bandwidth.

66. The method according to claim 65, wherein after the determining, by a first device, a frequency hopping parameter, further comprises:
sending, by the first device within the range of the dedicated bandwidth, signaling used to indicate the initial frequency hopping location to the second device.

67. A data transmission method, comprising:
determining, by a second device, a frequency hopping parameter and a quantity of retransmission times of to-be-received data, wherein the frequency hopping parameter comprises an initial frequency hopping location, a bandwidth of the to-be-received data, a frequency hopping offset, and a total frequency hopping bandwidth;
determining, by the second device, a first start location of the to-be-received data according to the quantity of retransmission times of the to-be-received data and the frequency hopping parameter; and
receiving, by the second device according to the first start location and the bandwidth of the to-be-received data, the to-be-received data sent by a first device.

68. The method according to claim 67, wherein the frequency hopping parameter further comprises a maximum quantity of retransmission times of the to-be-received data.

69. The method according to claim 67, wherein the determining, by the second device, a first start location of the to-be-received data according to the quantity of retransmission times of the to-be-received data and the frequency hopping parameter comprises:
if a current retransmission subframe belongs to a first time subset, determining, by the second device, the first start location of the to-be-received data from a relatively low frequency location to a relatively high frequency location according to the initial frequency hopping location, the bandwidth of the to-be-received data, the total frequency hopping bandwidth, and a product of the quantity of retransmission times and the frequency hopping offset; or if a current retransmission subframe belongs to a second time subset, determining, by the second device, the first start location of the to-be-received data from a relatively high frequency location to a relatively low frequency location according to the initial frequency hopping location, the bandwidth of the to-be-received data, the total frequency hopping bandwidth, and a product of the quantity of retransmission times and the frequency hopping offset.

70. The method according to claim 69, wherein the first time subset and the second time subset are the same or different.

71. The method according to claim 70, wherein the first time subset and the second time subset comprise any one of the following time subsets:
a time set comprising an even subframe;
a time set comprising an odd subframe;
a time set comprising a subframe corresponding to a subframe index when a sum of the quantity of retransmission times of the to-be-received data and the subframe index is an even number;
a time set comprising a subframe corresponding to a subframe index when a sum of the quantity of retransmission times of the to-be-received data and the subframe index is an odd number; or
a time set comprising all subframes.

72. A device, comprising:
a processor and a transmitter;
the processor is configured to determine a frequency hopping parameter, wherein the frequency hopping parameter comprises an initial frequency hopping location, a bandwidth of to-be-transmitted data, and a total frequency hopping bandwidth, and determine a first start location of the to-be-transmitted data according to the frequency hopping parameter;
the transmitter is configured to send the to-be-transmitted data to a second device according to the first start location and the bandwidth of the to-be-transmitted data.

73. The device according to claim 72, wherein the processor is further configured to: if a current retransmission subframe belongs to a first time subset, determine the first start location of the to-be-transmitted data according to the initial frequency hopping location and the total frequency hopping bandwidth; or if a current retransmission subframe belongs to a second time subset, determine the first start location of the to-be-transmitted data according to the initial frequency hopping location, the bandwidth of the to-be-transmitted data, and the total frequency hopping bandwidth.

74. The device according to claim 72, wherein the processor is further configured to: determine whether the maximum quantity of retransmission times is not greater than 2; and if the maximum quantity of retransmission times is not greater than 2 and a current retransmission subframe belongs to a first time subset, determine the first start location according to the initial frequency hopping location and the total frequency hopping bandwidth, or if the maximum quantity of retransmission times is not greater than 2 and a current retransmission subframe belongs to a second time subset, determine the first start location according to the initial frequency hopping location, the bandwidth of the to-be-transmitted data, and the total frequency hopping bandwidth.

75. The device according to claim 72, wherein the total frequency hopping bandwidth is a dedicated bandwidth used during data transmission, and the processor is further configured to determine, within a range of the dedicated bandwidth, the first start location of the to-be-transmitted data according to the frequency hopping parameter, and map the first start location to a physical resource of a system bandwidth.

76. The device according to claim 75, wherein the transmitter is further configured to send, within the range of the dedicated bandwidth, signaling used to indicate the initial frequency hopping location to the second device.

77. A device, comprising:
a processor and a receiver;
the processor is configured to determine a frequency hopping parameter and a quantity of retransmission times of to-be-received data, wherein the frequency hopping parameter comprises an initial frequency hopping location, a bandwidth of the to-be-received data, a frequency hopping offset, and a total frequency hopping bandwidth, and determine a first start location of the to-be-received data according to the quantity of retransmission times of the to-be-received data and the frequency hopping parameter;
the receiver is configured to receive, according to the first start location and the bandwidth of the to-be-received data, the to-be-received data sent by a first device.

78. The device according to claim 77, wherein the frequency hopping parameter further comprises: a maximum quantity of retransmission times of the to-be-received data.

79. The device according to claim 77, wherein the processor is further configured to: if a current retransmission subframe belongs to a first time subset, determine the first start location of the to-be-received data from a relatively low frequency location to a relatively high frequency location according to the initial frequency hopping location, the bandwidth of the to-be-received data, the total frequency hopping bandwidth, and a product of the quantity of retransmission times and the frequency hopping offset; or if a current retransmission subframe belongs to a second time subset, determine the first start location of the to-be-received data from a relatively high frequency location to a relatively low frequency location according to the initial frequency hopping location, the bandwidth of the to-be-received data, the total frequency hopping bandwidth, and a product of the quantity of retransmission times and the frequency hopping offset.

80. The device according to claim 79, wherein the first time subset and the second time subset are the same or different.

81. The device according to claim 80, wherein the first time subset and the second time subset comprise any one of the following time subsets:
a time set comprising an even subframe;
a time set comprising an odd subframe;
a time set comprising a subframe corresponding to a subframe index when a sum of the quantity of retransmission times of the to-be-received data and the subframe index is an even number;
a time set comprising a subframe corresponding to a subframe index when a sum of the quantity of retransmission times of the to-be-received data and the subframe index is an odd number; or
a time set comprising all subframes.
